(19) United States
(12) Patent Application Publication
(10) Pub. No.: US 2024/0242121 A1
(43) Pub. Date: Jul. 18, 2024

(54) SYSTEMS AND METHODS FOR TREATING CROP DISEASES IN GROWING SPACES

(71) Applicant: CLIMATE LLC, Saint Louis, MO (US)

(72) Inventors: Juan Lopez ARRIAZA, Martinez, CA (US); Kelsey BLACKSTONE, Maple Valley, WA (US); Laura HESS, Albany, CA (US); Hunter MERRILL, Saint Charles, MO (US); Maria WOJAKOWSKI, Milpitas, CA (US)

(21) Appl. No.: 18/410,962

(22) Filed: Jan. 11, 2024

Related U.S. Application Data
(60) Provisional application No. 63/438,975, filed on Jan. 13, 2023.

(51) Int. Cl. G06N 20/00; G06N 5/022; G06N 7/01

(52) U.S. Cl. CPC G06N 20/00; G06N 5/022; G06N 7/01

(57) ABSTRACT

Systems and methods for predicting likelihoods of multiple crop disease types for target plots. An example computer-implemented method includes receiving a request for a crop disease prediction related to treatment of a target plot for one or more crop diseases and accessing a multiple disease joint model consistent with location data included in the request. The computer-implemented method also includes determining, via the multiple disease joint model, first and second disease likelihood output based on at least the location data, where the first and second disease likelihood outputs are each associated with a different one of the multiple disease types, and generating a treatment recommendation based on the first and second disease likelihood outputs. The computer-implemented method then includes directing application of at least one treatment to the target plot, based on the treatment recommendation output.

### CROSS-REFERENCE TO RELATED APPLICATION

This application claims the benefit of, and priority to, U.S. Provisional Application No. 63/438,975 filed on Jan. 13, 2023. The entire disclosure of the above-referenced application is incorporated herein by reference.

### FIELD

The present disclosure generally relates to systems and methods for treating crop diseases in growing spaces, and in particular, to systems and methods for use in advising on decisions related to the application of treatments to the crops in the growing spaces, based on joint modeling for multiple crops and crop diseases.

### BACKGROUND

This section provides background information related to the present disclosure which is not necessarily prior art.

It is known for seeds to be grown in fields for commercial purposes, whereby crops from the fields, or parts thereof, are sold for business purposes and/or profit. For example, corn may be grown by a grower in numerous fields owned or operated by the grower, and the corn grown and harvested from the fields may then be sold. Similarly, in another example, soybeans may be grown by a grower in numerous fields owned or operated by the grower, and the soybeans grown and harvested from the fields may then be sold. Consequently, growers may seek to plant particular seeds based on specific aims of the growers (e.g., corn versus soybeans, etc.), specific climate conditions associated with the fields (e.g., drought tolerance, etc.), and disease resistance. In addition, growers may also rely on visual inspection of performance of the crops and presence of potential crop diseases, in order to make decisions regarding applications of treatments to the crops to inhibit or treat the potential crop diseases as the crops are growing.

### SUMMARY

This section provides a general summary of the disclosure and is not a comprehensive disclosure of its full scope or all of its features.

Example embodiments of the present disclosure generally relate to computer-implemented methods for use in identifying treatments for crop diseases in growing spaces. In one example embodiment, such a method for identifying treatments generally includes receiving, by a computing device, a request for a crop disease prediction related to treatment of a target plot for one or more crop disease, the request including crop disease type data and location data relating to the target plot, the crop disease type data including multiple identifiers each associated with a different one of multiple crop disease types; accessing, by the computing device, a multiple disease joint model consistent with the location data; determining, by the computing device, via the multiple disease joint model, a first disease likelihood output (e.g., a disease occurrence output, a disease severity output, a combination thereof, etc.) and a second disease likelihood output (e.g., a disease occurrence output, a disease severity output, a combination thereof, etc.) based on at least the location data, the first disease likelihood output and the second disease likelihood output each associated with a different one of the multiple disease types; generating, by the computing device, a treatment recommendation based on the first disease likelihood output and the second disease likelihood output of the multiple disease joint model; and directing, by the computing device, application of at least one treatment to the target plot, based on the treatment recommendation output.

Example embodiments of the present disclosure generally relate to systems for use in identifying treatments for crop diseases in growing spaces. In one example embodiment, such a system generally includes at least one computing device configured to receive a request for a crop disease prediction related to treatment of a target plot for one or more crop disease, the request including crop disease type data and location data relating to the target plot, the crop disease type data including multiple identifiers each associated with a different one of multiple crop disease types; access a multiple disease joint model consistent with the location data; determine, via the multiple disease joint model, a first disease likelihood output (e.g., a disease occurrence output, a disease severity output, a combination thereof, etc.) and a second disease likelihood output (e.g., a disease occurrence output, a disease severity output, a combination thereof, etc.) based on at least the location data, the first disease likelihood output and the second disease likelihood output each associated with a different one of the multiple disease types; generate a treatment recommendation based on the first disease likelihood output and the second disease likelihood output of the multiple disease joint model; and direct application of at least one treatment to the target plot, based on the treatment recommendation output.

Example embodiments of the present disclosure also generally relate to non-transitory computer readable storage media including computer-executable instructions for use in identifying treatments for crop diseases in growing spaces, which when executed by at least one processor, cause the at least one processor to perform one or more of the above operations.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 illustrates an example system for use in determining whether to treat crops in growing spaces, based on joint modeling of multiple diseases potentially present in the crops;

FIG. 2 illustrates an example method, that may be used and/or implemented in the system of FIG. 1, for determining whether to treat one or more of multiple potential crop diseases in a growing space, or not, based on a joint model prediction of multiple specific candidate crop diseases;

FIG. 3A illustrates an example disease risk map view showing disease probabilities over various locations;

FIG. 3B illustrates an example time series forecast view showing changes in disease probability over time for a target field;

FIGS. 4A and 4B illustrate an example logical organization of sets of instructions in main memory of a computing device, when an example application is loaded on the computing device for execution, which may be used in connection with the system of FIG. 1 and/or the method of FIG. 2; and

FIG. 5 is a block diagram that illustrates a computing device (or computer system) upon which embodiments of the system of FIG. 1 and/or the method of FIG. 2 may be implemented.

Corresponding reference numerals indicate corresponding parts throughout the several views of the drawings.

### DETAILED DESCRIPTION

Example embodiments will now be described more fully with reference to the accompanying drawings. The description and specific examples included herein are intended for purposes of illustration only and are not intended to limit the scope of the present disclosure.

Growers make decisions related to the planting, treatment, and harvesting of crops in growing spaces, often with the aim of enhancing the performance of the crops in the growing spaces. One example decision relates to application, or non-application, of a fungicide or other treatment to a crop in a growing space, to inhibit or treat one or more of multiple potential crop diseases therein. In general, given the cost associated with the treatment, a grower of the crop is likely to decide to apply the treatment based on an expected impact on the performance of the crop (including a likelihood that the crop develops one or more corresponding diseases and the potential impact of the diseases on the crop), which, conventionally, is not predictable at desired levels of accuracy. As such, growers' decisions related to applications of in-season treatments (such as fungicides, etc.), in general, are susceptible to inaccuracy, often leading to underuse and the associated costs of the damaged crop and/or overuse and the associated costs of the wasted treatment, etc.

Uniquely, the systems and methods herein provide for determining whether to treat one or more of multiple potential crop diseases in a growing space, or not, based on a joint model prediction of multiple specific candidate crop diseases. In particular, data associated with growing spaces (e.g., plots, etc.) in a first region and in a second region (e.g., trial plot data, etc.) are accessed and manipulated in one or more manners to provide data indicative of disease presence or absence and/or disease severity for multiple crop disease types, in the growing spaces and in the regions. The data are then used to train a multiple disease joint model such as, for example, a model using coregionalization to jointly model multiple disease probabilities (e.g., occurrence, severity, etc.) (e.g., where information is shared across diseases, space and time using a separable covariance function; etc.). The trained model is then employed, in connection with multiple candidate crop diseases, whereby the modeling provides a recommended decision, based on the trained model, to apply or to not apply a treatment associated with one or more crop diseases.

Following the above, the decision is then issued to the grower, whereby the grower is then permitted to rely on the decision (and, as desired, implement the decision in the growing space). Additionally, or alternatively, the modeling output issued to the grower may include a time series forecast view of disease for the field(s), or a disease risk map view for the field(s) and adjacent fields(s), whereby the grower is then enabled to determine, based on viewing the predicted probabilities in the given view(s), whether to apply or not to apply a treatment associated with one or more crop diseases. In this manner, objective data-based criteria are employed to inform decisions related to applications of treatments to crops in growing spaces for multiple potential crop diseases, in lieu of subjective understandings of the crops in the fields (e.g., by the grower, etc.) and about potential impacts and/or propriety of the treatments.

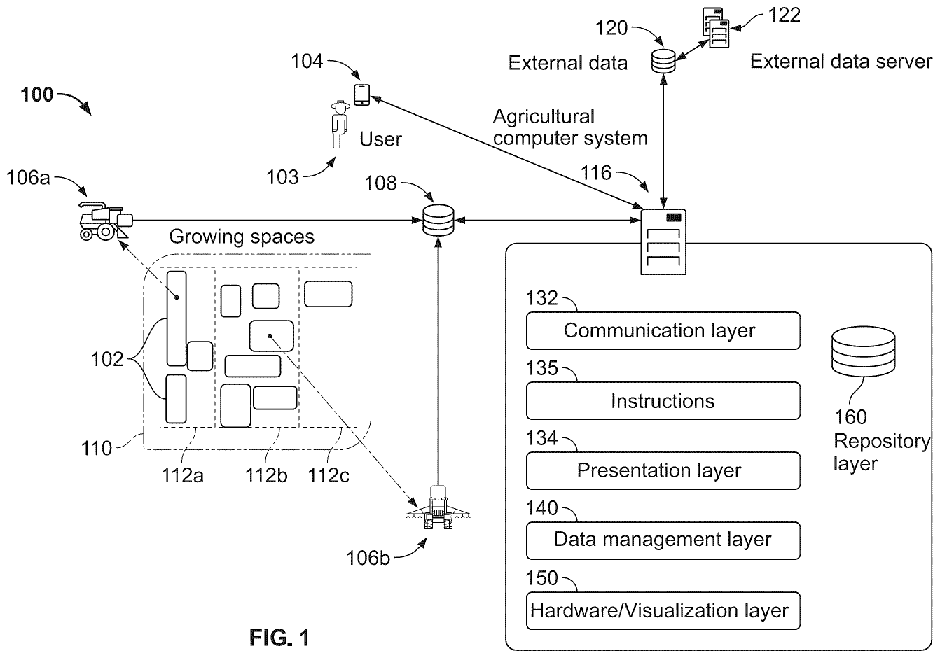

FIG. 1 illustrates an example system 100 in which one or more aspect(s) of the present disclosure may be implemented. Although the system 100 is presented in one arrangement, other embodiments may include the parts of the system 100 (or other parts) arranged otherwise depending on, for example, types of crops; types of crop diseases present in growing spaces; types and/or locations of growing spaces; and/or privacy and/or data requirements; etc.

The system 100 generally includes various growing spaces (e.g., plots 102, etc.), for example, associated with a user 103 (e.g., a grower, etc.). The plots 102 are shown in solid lines in FIG. 1 within region 110.

As shown in FIG. 1, the plots 102 are included within the region 110, and are further organized (or separated, etc.) into different fields 112a-c (which are also included within the region 110). The region 110 and fields 112a-c are represented by dotted lines. The region 110 in turn may include and/or may be defined by postal codes, area codes, counties, a group of counties, a state, a group of states, territories, a group of territories, a country, a group of countries, or other geo-political boundaries or non-geo-political boundaries (e.g., a watershed, a group of watersheds, a maturity band, a group of maturity bands, etc.), etc. It should be appreciated that other system embodiments may include hundreds or thousands, or more or less, plots, and tens, hundreds or thousands of fields, regions, etc.

In the illustrated embodiment, the plots 102 may be part of any type of field in which crops are grown and harvested. The plots 102 may be owned by the user 103, or otherwise operated and/or managed by the user 103, for example, in the business of growing, harvesting, and selling crops. In connection therewith, the user 103 may alter conditions of the plots 102, as the seeds grow into plants (e.g., in season, etc.) (e.g., through treatments, irrigation, etc.), and then harvest the crops with a variety of different farm equipment (e.g., combines, pickers, etc.) (as explained below).

In connection with the above, data (e.g., agronomic data, etc.) are gathered at or from the plots 102. The data may be gathered manually, or automatically, for example, by farm equipment, etc. The data may include plant/seed identifiers, plant/seed types, crop disease identifiers and/or types, crop disease presence observations, crop disease severity observations (e.g., on a scale of severity), observation dates, planting dates, growing temperature days, location data, field identifiers, soil conditions (e.g., moisture, drainage, etc.), plant performance (e.g., height, strength, yield, etc.) (e.g., at one or more regular or irregular interval(s), etc.), plant growth stages, treatments, weather conditions (e.g., precipitation, temperature, humidity, etc.), field topology (e.g., elevation, change in slope, surrounding terrain, etc.), management practices (e.g., crop rotation, fungicide application, tiling, etc.), and other suitable data to identify the seed/plant, a performance of the seed/plant, crop diseases associated with the seed/plant, etc., in the plots 102.

Although data are described in some example embodiments with reference to the plots 102, it should be appreciated that data may be gathered at the field level (e.g., for one plot or more than one plot, etc.), at a region level (e.g., for multiple fields and multiple plots, etc.), etc., and may be broadly referred to as gathered for the growing spaces (where the growing spaces may be at the plot level, at the field level, etc.).

With continued reference to FIG. 1, the system 100 also includes farm equipment 106a-b (e.g., agricultural machines, etc.), a data server 108 (or multiple data servers), and an agricultural computer system 116, each of which is coupled to (and is in communication with) one or more network(s). The network(s) is/are indicated generally by arrowed lines in FIG. 1, and may each include, without limitation, one or more of a local area network (LAN), a wide area network (WAN) (e.g., the Internet, etc.), a mobile/cellular network, a virtual network, and/or another suitable public and/or private network capable of supporting communication among parts of the system 100 illustrated in FIG. 1, or any combination thereof.

In this example embodiment, the farm equipment 106a-b may include, without limitation, one or more harvesting devices, sprayers, planters, etc. As shown in FIG. 1, for example, the farm equipment 106a may include, for example, a combine, a picker, or other mechanism for harvesting plants/crops, etc., while the farm equipment 106b may include a sprayer or other mechanism for delivering a desired treatment to plants/crops in the plots 102. Additionally, or alternatively, the farm equipment 106a-b may include planters, tillers, irrigators, or other suitable equipment, configured to carry out one or more operations at the plots 102, such as, for example, application of treatments, irrigation, etc.

It should also be appreciated that a different number and/or type of farm equipment, which may be distributed differently among the different plots 102, may be included in other system embodiments.

The farm equipment 106a-b is also configured to measure, capture, or identify data, and additionally to compile data, which are specific to the crop and/or plots 102 as the equipment is performing the defined task related to the crop or plot 102, etc. The data may include, without limitation, rates, soil compositions, times, dates, yield, weights, applications, moisture content, volumes, flow, or other suitable data, etc., relating to treatments, irrigation, harvested crops, etc. Moreover, in this example, the farm equipment 106a-b may be configured to track their locations at given times, as each traverses the plots 102, as expressed in latitude/longitude coordinates, or otherwise, and to correlate the locations to other data gathered/compiled by the farm equipment 106a-b (e.g., permitting the data to be correlated to a specific plant and/or seed based on planting data for the growing spaces, etc.).

In some example embodiments, the user 103 and/or another crop disease investigator may inspect the crops and/or plots 102 to observe whether crop disease is present and, when present, severity of the crop disease. Crop diseases may be identified via visual inspection, via a specified test protocol, and/or via any other suitable techniques for determining whether a disease is present, or not, in the crop. When disease is identified, the disease observations may indicate a presence in the field or plot (e.g., 1 for disease present, 0 for disease not present; etc.) and/or the disease observations may indicate a severity of the disease on a scale, such as an integer scale from 0 to 9, a ranking of level 1, level 2, etc. The crop disease observations may be logged as crop disease observation data and may include the specific type of crop and the specific type of disease (e.g., corn grey leaf spot, soybean frogeye leaf spot, corn northern leaf blight, corn southern rust, soybean white mold, etc.), along with the presence and/or severity, as desired or required, etc. The crop disease observations are further logged with a date of observation and a location of observation (such as a latitude and longitude of the plot 102), etc. (included in the disease observation data). As indicated, the observation from the crop disease investigator may be based on visual inspection of crops at various plots at various locations for multiple different types of crops and multiple different types of disease.

Table 1, for example, illustrates the disease observation data from the crop disease investigator in various ones of the plots 102.

TABLE 1

| Plot | | | Severity | Observation | Treatment |
|---|---|---|---|---|---|
| ID | Crop | Disease | rating | date | date |
| A | corn | Grey leaf spot | 0 | 2022 Jul. 1 | NA |
| B | soybeans | Frogeye leaf | 3 | 2022 Jul. 19 | 2022 Jun. 30 |
| | | spot | | | |
| . . . | . . . | . . . | . . . | . . . | . . . |

Additionally or alternatively, crop disease observation data may be obtained from further manual, automatic or semi-automatic data sources such as, for example, from the equipment 106a-b, from the CLIMATE FIELDVIEW Scouting Notes application or from other similar entry applications, tools, or features, etc., commercially available from Climate LLC, Saint Louis, Missouri, etc. or otherwise.

As indicated above, the farm equipment 106a-b may be configured to measure, capture or identify soil information, such as a soil moisture content, drainage level, etc. In one example, the farm equipment 106a-b may include one or more instruments for measuring a current moisture level of the soil, for measuring a rate of water drainage from the soil over time, etc. Additionally, or alternatively, the plots 102 may include one or more instruments disposed therein for measuring soil conditions to generate soil data, whereby the user 103 and/or soil investigator may obtain the soil data therefrom at one or more regular or irregular intervals, etc.

The farm equipment 106a-b and/or computing devices associated with the user 103 and/or investigator(s) (e.g., communication device 104, etc.) may be further configured to transmit the gathered data to the data server 108. That said, a different number of data servers may be included in other system embodiments, with the different data servers each potentially being specific to certain ones (or more) of the plots 102 or fields or regions, etc.

The data server 108, in turn, is configured to store the received data in one or more data structures. In general, in this example embodiment, the data server 108 is configured to store data by year (e.g., Year_X, Year_X+1, etc.), which corresponds to the different growing years (e.g., 2015, 2016, 2017, etc.) for the plots 102 (and/or trials, plots, fields, etc. within the growing spaces, etc.). Then, for each year, the data includes data for each of the plots/fields/growing spaces including, for example (and without limitation), presence and severity of multiple different crop disease types (such as, for example, an integer severity scale), performance, identifier, brands for seeds, relative maturity, planting dates, growing temperature days, growing mode of action, prior crops, types of traits or trait stacks, treatments, positions/distributions of seeds in the plots 102 (e.g., seeding rates, etc.), location definitions of the plots 102 or of seeds within the plots 102 (e.g., field boundaries, latitude and longitude, centroid of a plot or other boundary, etc.), acreage of the growing spaces, populations of seeds planted in the plots 102, yields and harvest moisture (e.g., based on location and seed products, etc.), etc. The data may also include soil conditions (e.g., soil moisture, drainage levels, etc.), field elevations (which may include slopes of a plot, surrounding terrain information, etc.), precipitation amounts, relative humidity, temperature, solar radiation, irrigation amounts, management practices (e.g., crop rotation, fungicide application, tiling, drainage, etc.) or any other data indicative of the growing conditions for the seeds/plants in the given plots 102, etc.

It should be appreciated that any available and/or desired data may be collected with regard to the plots 102 and/or the crops planted therein. What's more, the data included in data structure(s) of the data server 108 may be augmented with additional information about the crops and/or plots 102 from one or more other sources, including, for example, weather data, treatment data sheets and/or details, boundary data (e.g., boundary definitions, centroids, etc.), field topology data, crop disease type data, etc.

Given the above, in this example embodiment, the agricultural computer system 116 is programmed, or configured, to receive a request for a crop disease prediction related to treatment of a target plot, and then to generate a treatment decision (e.g., a recommendation, etc.). For example, the user 103 may make the request with regard to one or more of the plots 102, where the request includes one or more potential crop disease types (e.g., based on the crops in the plots 102, based on past experience or historical diseases, etc.) and a location of the one or more plots 102. In various implementations, the user 103 may submit the request for the treatment in-season or within a defined interval of a predicted or known growth stage of the crop in the one or more plots 102. While it should be appreciated that the request may be received at any time during the growing season, in one embodiment, the request may be received in an interval relative to the VT growth stage for corn (e.g., within an interval (e.g., two days, five days, ten days, two weeks, four weeks, etc.) prior to the VT growth stage, etc.), because, for example, the treatment for one or more potential crop diseases may be applied (if recommended) in the VT growth stage.

Based on the above, in this example embodiment, the agricultural computer system 116 is configured to train a joint disease model, which is based on appropriate data, and then to make the one or more insight views, predictions, recommendations, etc., based on the trained joint disease model, as described herein.

In particular, the agricultural computer system 116 is configured to access data from the data server 108, which is relevant to prediction of crop disease (e.g., based on locations of the target plots, potential crop disease types, etc.).

The agricultural computer system 116 is configured to access data for plots in the region(s) of the target plot, including, without limitation, planting dates (e.g., days of the year in which crops were planted in the fields, etc.), seeding rates for the fields, surfactants applied (or not) to the plots, modes of action (e.g., a succinate dehydrogenase inhibitor (SDHI), a demethylation inhibitor (DMI), quinone outside inhibitors (QoI), or other effectivity targets of treatment, etc.), weather data, product maturity (e.g., relative maturity (RM), etc.), drought data, previous year crops data (broadly, crop rotation data), soil data, location data, tillage types, binned application timing, etc. It should be appreciated that the accessed data, in this example embodiment, will generally include multiple different crops and may be from (or stored in) multiple sources (e.g., five, eight, ten, twenty, etc.) of published, public and/or private data.

In addition, the agricultural computer system 116 is configured to access data from the data server 108 relating to different diseases and different crops for the relevant region(s). In doing so, the data may include disease observation data, as described above, which is indicative of the presence and/or severity of different crop disease types over multiple years (e.g., ten years or more or less, etc.), where plot locations, dates of observations throughout the growing season, plot conditions, plot management practices, etc., vary for the given crop of observation data.

Once the desired data is accessed (or prior), the agricultural computer system 116 is configured to identify regions for the model training, and specifically in this example, the region 110 in which the target plot is located. For example, the agricultural computer system 116 is configured to identify a county, in general or in which a target plot is located, based on the boundary definition of the county (along with the location data for the target plot/field), or based on a county identifier included in the data associated with the target plot in the data server 108, etc. In another example, the agricultural computer system 116 is configured to identify a state in which the identified county is located based on the boundary definition of the state (along with the location data for the target plot/field and/or boundary data for the county), or based on a state identifier included in the data associated with the target plot/field in the data server 108, etc. In yet another example, agricultural computer system 116 is configured to identify a maturity band associated therewith, etc.

Specific data indicative of the region 110 (in this example) may also be determined or retrieved or conditioned for the regions (e.g., based on a centroid location for the county, based on a centroid location for the state, etc.). In view of the above, it should be appreciated that the data described herein may be retrieved, and then limited based on specific region(s) in which the target plot is located, or only data specific to the region(s) in which the target plot is located may be retrieved.

It should also be appreciated that other regions may be identified in other example embodiments for accessing data, based on different data, regions, bands, etc. (e.g., maturity bands, watersheds, etc.). For example, the region for accessing data may extend to a third (or more) region (broader than the region 110), such as, for example, a country, whereby the region hierarchy includes county, state and country, etc., in one example, and/or a city, whereby the region hierarchy includes city, county, state (and then, potentially even further, country) in another example.

The agricultural computer system 116 may be configured to manipulate the accessed data, including, specifically, the crop disease observation data (e.g., average, mean, etc.) for the regions and to assign the manipulated data (e.g., the crop disease observation data, etc.) for the plot, or region, to a centroid location thereof. For example, the average seeding rate, average planting day of the year, and the mean product maturity may also be determined or retrieved and then assigned, per regional centroid, for the accessed data for the given region(s). As such, the centroid of the field 112a, for example, may be assigned manipulated crop disease type data for the specific field 112a (including the plots therein), and likewise for other fields in the region 110, and/or the regional centroid of the region 110 may be assigned manipulated crop disease observation data (e.g., an average occurrence of multiple crop disease types for the entire region 110 (including the fields and plots therein), an average severity of multiple crop disease types for the entire region 110 (including the fields and plots therein), etc.).

In this example embodiment, feature engineering based on domain knowledge and/or machine learning techniques may be applied to certain predictors to make the data more immediately useful for predicting potential crop disease (e.g., occurrence, severity, etc.). For example, the agricultural computer system 116 may be configured to convert the relative humidity and temperature into a total count of hours in which the temperature and moisture conditions (e.g., based on one or more ranges, etc.) are optimal for fungal disease growth and/or to encode time series of weather predictors by a neural network to create a set of low-dimensional weather features, etc. The agricultural computer system 116 is configured to transform predictors with significant skewness in distribution to partially remove some of the skewness. For example, rainfall may be transformed using a natural logarithm, etc. Beyond the above, the agricultural computer system 116 is configured to impute missing data using one or more global or regional averages. For example, the planting date might be imputed using the average planting date from the county in which the field is located, etc.

After the data is accessed, and manipulated (as applicable) as explained above, in connection with training, the accessed manipulated data is then separated into a training data set and a validating data set, where each data set includes specific crop disease observation data, plot data, etc., as described above. The training data and the validation data may be separated randomly and/or based on one or more years left out of schemes, etc.

Next, in this example embodiment, the agricultural computer system 116 is configured to train the multiple disease joint model based on the training data set. The multiple disease joint model may include, but is not limited to, a model that uses coregionalization to jointly model multiple crop disease type occurrence probabilities and/or severity probabilities (and/or ratings). For example, information may be shared in the multiple disease joint model across different crop disease types, different locations of plots, different observation dates, etc., with a separable covariance function.

For example, with reference to the expressions below, y_{i,s,t} is indicative of disease occurrence (e.g., 1 if disease was present, 0 if disease was not present; etc.) for disease i at location s at timepoint t. The variable Y is a collection of all disease occurrences into a single vector, while p_{i,s,t} is the probability that y_{i,s,t} is equal to one (e.g., the probability that disease i is observed at s, t; etc.) and P is the collection of those probabilities into a single vector. In connection therewith, the multiple disease joint model is defined, as a latent Gaussian process model, as:

$${y}_{i , s , t} \sim Bernoulli ( {p}_{i , s , t} ) \\ logit ( P ) \sim Normal ( μ , Σ ( θ ) )$$

where μ is a mean function of the latent Gaussian process, and Σ is the covariance matrix that depends on covariance parameters θ. Specifically, the j,k^{th} element of Σ is a covariance between the j^{th} and k^{th} elements of the logit of P. Training the model includes using data to estimate the mean function and covariance function, and the predictions are made using a formula for the conditional mean of the posterior Gaussian process of the logit of P given the data Y. In various embodiments, the mean function may be either a linear or a nonlinear function of space and time, for example, to account for the scale patterns of disease occurrence (e.g., southern rust is more prevalent in the south, and slowly makes its way north as the season progresses; etc.). Other scale nonlinear variations in disease risk is modeled by the covariance matrix Σ. A covariance function that defines elements of Σ may be given by a space-, time-, and disease-separable covariance function, for example, as:

$$Cov ( {w}_{i , s , t} , {w}_{{i}^{′} , {s}^{′} , {t}^{′}} ) = B [ i , {i}^{′} ] exp ( - ‖ s - {s}^{′} ‖ / {ϕ}_{1} ) exp ( - \vert t - {t}^{′} \vert / {ϕ}_{2} )$$

where w=logit(p). B is a matrix containing the pairwise correlation parameters for each pair of diseases (e.g., B[i,i′] would be the correlation between disease i and i′ if they were observed at the same time and place, etc.). And, ϕ₁ is the rate of decay of correlation across spatial distances, and ϕ₂ is the rate of decay of correlation across temporal distances (and the parameters B, ϕ₁ and ϕ₂ are collected into a single vector θ to ease notation). It should be understood then that the pairwise correlation between two diseases is reduced as their distance across space and time grows. It is the covariance structure that provides for sharing of information across diseases, even if the diseases are not observed at the same time and place.

In addition to the above, the multiple disease joint model may be extended to predict both the probability of disease occurrence and the disease severity, simultaneously. For instance, with reference to the expressions below, if z_{i,s,t} is indicative of severity ratings (e.g., an integer between 0 and 9 indicating the severity for disease i at location s and timepoint t, etc.), then the multiple disease joint model may be defined as a latent Gaussian process model, as:

$${z}_{i , s , t} \sim Ordinal ( {f}_{i , s , t} ; σ , {a}_{0} , {a}_{1} , … , {a}_{8} ) \\ F \sim Normal ( μ , Σ ( θ ) )$$

where, for example, f_{i,s,t} is a latent function; α₀, α₁, . . . , α₈ are bin width parameters, for example, chosen by a user (e.g., a data scientist, etc.) prior to training; σ is a likelihood parameter; μ, Σ, θ are latent process parameters; and F is normally distributed. Again, training the model generally includes using data to estimate the mean function and covariance function.

The bin width parameters generally represent cut points used to assign ranges of the continuous latent Gaussian process to the discrete disease severity values using one or more of the formulas below. The bin width parameters may include suitable values such as, for example, equally spaced values centered at zero (e.g., a₀=−4, a₁=−3, a₂=−2, . . . , a₇=3, a₈=4, etc.), etc. An example visualization of such bin width parameters is provided in Table 2 (illustrating integer severity rating categories over the bin width parameters in the latent process range).

TABLE 2

| Integer Severity Rating Cat. | | | | | | | | | | | | | | | | | | | | |
|---|---|---|---|---|---|---|---|---|---|---|---|---|---|---|---|---|---|---|---|---|
| \| | 0 | \| | 1 | \| | 2 | \| | 3 | \| | 4 | \| | 5 | \| | 6 | \| | 7 | \| | 8 | \| | 9 | \| |

| | | | | | | | | | |
|---|---|---|---|---|---|---|---|---|---|
| Bin Width | −4 | −3 | −2 | −1 | 0 | 1 | 2 | 3 | 4 |
| Parameters | | | | | | | | | |

As shown in Table 2, values of the latent process below −4 will map to high probabilities of integer rating 0; values between −4 and −3 will map to high probabilities of integer rating 1; etc. As such, as can be seen, the bin width parameters are boundaries in between each severity rating category. For instance, as an example, for a given location and time, the multiple disease joint model may output a value of 1.3 for the latent process for Grey Leaf Spot. The value 1.3 falls between bin width parameters 1 and 2, which corresponds to integer category 6. Integer category 6 will therefore have the highest predicted probability. Also 1.3 is closer to bin width parameter 1 than it is to bin width parameter 2, so the probability of integer category 5 will be higher than the probability of integer category 7 (but with integer category 6 still being the highest probability overall). The probabilities of other categories will be close to zero. A user (e.g., a farmer, a grower, etc.) associated with the given location, then, in this example, may see a predicted corn Grey Leaf Spot disease severity rating of “6”, or “between 5 and 7,” because these are the highest probability categories (in this example).

Also in the above, the likelihood parameter σ is estimated during training, the bin width parameters α₀, α₁, . . . , α₈ are fixed, and the latent process parameters μ, Σ, θ are defined as above. In turn, the predicted probabilities, p, for each integer category of a disease severity rating at a new location and timepoint is computed using the formulas:

$$p ( Z = 0 ) = ϕ ( {a}_{0} - \frac{F}{σ} )$$

$$p ( Z = 1 ) = ϕ ( {a}_{1} - \frac{F}{σ} ) - ϕ ( {a}_{0} - \frac{F}{σ} )$$

$$p ( Z = 2 ) = ϕ ( {a}_{2} - \frac{F}{σ} ) - ϕ ( {a}_{1} - \frac{F}{σ} )$$

$$…$$

$$p ( Z = 9 ) = 1 - ϕ ( {a}_{8} - \frac{F}{σ} )$$

where ϕ is a probit function (e.g., a rate of decay of correlation across spatial distances, etc.). Note that severity ratings can be predicted with either the formula for the expected value 0 p(Z=0)+ . . . +9· p(Z=9) or the rating with the highest probability argmaxi=_{i∈{0, . . . ,9}}P(Z=i), and the probability of occurrence can also be predicted with the formula 1−p(Z=0), so the above provides one model that is configured to predict severity and occurrence for multiple diseases for multiple crops simultaneously (e.g., a single model may be trained to predict the probability of occurrence of grey leaf spot, the severity of tar spot, etc.).

It should be appreciated that in view of the above, a mean function of the model may process additional input features related to a plot (e.g. beyond a location and observation date for the plot, etc.), such as weather, crop management practices, relative humidity, temperature, tillage type, seeding rate, field topology, seed hybrid/genetic information, soil information, etc. Example mean functions may include, but are not limited to, linear regression models, neural network regression models, etc. And, alternatives to the separable disease-space-time covariance function, which is provided above, may also be employed, such as, for example, a neural network kernel function. Local case-control sampling may also be used to adjust for biases due to unbalanced data in one or more embodiments.

It should be appreciated that a number of suitable models may be used for jointly modeling occurrence and/or severity probabilities for multiple crop disease types, which may be useful in applications where dependencies across multiple crop disease types, target plot locations, etc., are anticipated. Some example model architectures may include, but are not limited to, multivariate modeling, multi-task learning, simultaneous prediction, coregionalization with a separable covariance function, linear regression, neural network regression, a neural network covariance function, vector autoregression, multi-task learning, shared smoothing penalties, etc.

In addition to, or as an alternative to the above, it should be appreciated that vector autoregression may be used for a multivariate time series where each variable is a linear combination its own lag values and the lag values of other variables. The model may include a system of linear equations with one equation per variable, as illustrated in the example below.

$${Y}_{1 , t} = {α}_{1} + {β}_{11 , 1} {Y}_{1 , t - 1} + {β}_{12 , 1} {Y}_{2 , t - 1} + {β}_{13 , 1} {Y}_{3 , t - 1} + {β}_{11 , 2} {Y}_{1 , t - 2} + {β}_{12 , 2} {Y}_{2 , t - 2} + {β}_{13 , 2} {Y}_{3 , t - 2} + {ϵ}_{1 , t} \\ {Y}_{2 , t} = {α}_{2} + {β}_{21 , 1} {Y}_{1 , t - 1} + {β}_{22 , 1} {Y}_{2 , t - 1} + {β}_{23 , 1} {Y}_{3 , t - 1} + {β}_{21 , 2} {Y}_{1 , t - 2} + {β}_{22 , 2} {Y}_{2 , t - 2} + {β}_{23 , 2} {Y}_{3 , t - 2} + {ϵ}_{2 , t} \\ {Y}_{3 , t} = {α}_{3} + {β}_{31 , 1} {Y}_{1 , t - 1} + {β}_{32 , 1} {Y}_{2 , t - 1} + {β}_{33 , 1} {Y}_{3 , t - 1} + {β}_{31 , 2} {Y}_{1 , t - 2} + {β}_{32 , 2} {Y}_{2 , t - 2} + {β}_{33 , 2} {Y}_{3 , t - 2} + {ϵ}_{3 , t}$$

In the example model equation above, the B values may refer to correlations between the different crop disease types, and the a values may be considered as offsets or intercepts of the equations. Y₁, Y₂ and Y₃ refer to different crop disease types, and each t element refers to an observation at a different time. For example, Y_{1,t} refers to a disease observation for a first crop disease type at a time t, Y_{2,t} refers to a disease observation for a second crop disease type at the time t, and so on. Similarly, Y_{1,t-1} refers to a disease observation for the first crop disease at a time t−1, Y_{1,t-2} refers to a disease observation for the first crop disease at a time t−2, and so on. Therefore, a disease observation for a first disease type at a current time is a function of disease observation values for the first disease type and other disease types, at multiple time intervals prior to the current time.

As should be appreciated, accuracy of the model may be implemented with various different frequencies of observations. For example, the time interval for recording disease observations may be once a week in some applications, once every three days, or daily, as desired and/or available, etc.

As another example model, a shared smoothing penalty model may be implemented with smooth functional relationships between predictor and response varying between groups. For example, a growth stage of different crop varieties may vary along a common temperature/precipitation gradient, disease severity of different species may vary along a common geo-spatial area, etc. Coregionalization may be implemented in hierarchical spatiotemporal models, where observations are correlated across space, time and targets. For example, corn and fungal diseases in the United States may have correlations across locations of plots and dates of observations.

As another example model architecture, multi-task learning may be used in, for example, deep learning models that predict multiple targets, where some hidden layers are shared across targets. For example, imagery-based corn and soy yield predictions in the United States may be predicted using multi-task learning. In various implementations, a Gaussian process model may interpolate data across space and time (e.g., across locations of plots and crop disease observation dates, etc.). For example, an output of the multiple disease joint model may include an output of a neural network combined with a smooth Gaussian process. Example joint model frameworks described herein may be implemented in any suitable computer architecture, such as the Python package GPFlow.

Based on the above, the agricultural computer system 116 is configured to output a trained multiple disease joint model and to store the trained multiple disease joint model in memory. The agricultural computer system 116 is configured to validate the trained model based on the validation data set defined above. In particular, the agricultural computer system 116 is configured to expose the input data of the validation data set to the trained model, and then to compare the crop disease prediction output to the crop disease observation data included in the validation data set. When the crop disease prediction data is consistent with the crop disease observation data, subject to an applicable threshold, the trained model is accurate. The percentage of correct predictions provides a performance, and when the performance of the trained model is as desired or expected, the trained model is designated, by the agricultural computer system 116, for use in providing crop disease predictions related to the original request (and/or others).

In this example embodiment, the multiple disease joint model is trained, by the agricultural computer system 116, in response to the request from the user 103, for example, for the crop disease prediction (or treatment recommendation) regarding multiple potential crop diseases for the target plot. That said, in other embodiments the agricultural computer system 116 may be configured to train the model for specific combinations of potential crop diseases and regions, whereby the model may be trained and validated prior to receipt of the request from the user 103, or another user in any of the fields 112a-c, region 110, or other regions, etc. What's more, it should be appreciated that once trained (either in response to a request, or in general), the model may be updated or retrained at one or more intervals, to, for example, promote the inclusion of up-to-date information from the plots 102 (e.g., fields, etc.) in the regions. The interval may be weekly, monthly, bi-monthly or a shorter or longer interval depending, for example, on the available data from the regions (e.g., which may alter the model, etc.).

After training is complete, the agricultural computer system 116 is configured to predict disease likelihoods (e.g., occurrences, severities, combinations thereof, etc.) for multiple crop disease types, in response to the user's request, and to recommend the user 103, in the illustrated embodiment, to treat or not treat one or more of the plots 102 (e.g., of a target field from the request, etc.) with a treatment (e.g., with fungicide, etc.) based on the predicted disease likelihoods.

In connection therewith, the agricultural computer system 116 is configured to make the prediction of disease likelihoods by inputting the details of the target plot to the trained multiple disease joint model. For example, in some implementations, only a location of the target plot may be input to the trained multiple disease joint model, and the agricultural computer system 116 is then configured, by the trained model, to output a prediction of crop disease likelihoods for the target plot for multiple crop disease types at the location of the target plot. In other implementations, the input to the trained multiple disease joint model may include a date or range of dates, in addition to the location of the plot. For example, the user 103 may desire to determine crop disease likelihoods at the location of the plot within the remaining calendar year, within the next three months, during a future growing season, etc. In some implementations, the input to the trained multiple disease joint model may include other characteristics of the target plot, including but not limited to, planting date, soil information of the target plot, weather information associated with the target plot, management practices of the target plot including tillage, field topology information of the target plot, crop type information associated with the target plot, etc.

The agricultural computer system 116, then, is configured to issue an output as a recommendation to the user 103 (e.g., via a transmission to a communication device 104 associated with the user 103, etc.) to either treat or not treat the target plot consistent with the predicted crop disease likelihoods (as indicated in the request).

With continued reference to FIG. 1, in this example embodiment, the agricultural computer system 116 is programmed, or configured, to issue the crop disease likelihood predictions to the user 103 in one or more forms. In particular, the crop disease likelihood predictions may be provided in combination with one or more probabilities in an interface displayed to the user 103 at the communication device 104.

The treatment recommendation may then be selected by the user 103, where the user 103 may then order and/or purchase the treatment product(s), for instance, via the agricultural computer system 116, etc. (e.g., whereby the agricultural computer system 116 receives the order, purchase request, etc., from the user 103, in response to output of the treatment decision to the user 103 and a corresponding agreement to the decision and/or recommendation by the user 103, etc.). The agricultural computer system 116 may then direct the selected treatment(s) to the user 103 (e.g., delivering the treatment to the target field, etc.). Further, the candidate treatment may be applied, by the user 103 or other party, for example, to the target field (e.g., as represented by one or more of the growing spaces, etc.). This may include the user 103 receiving the treatment and operating farm equipment (e.g., one or more of equipment 106a-b, etc.) to treat the target field. Alternatively, this may include the agricultural computer system 116 generating instructions based on the treatment and providing the instructions to the farm equipment 106a-b, for example, whereby the farm equipment 106a-b is configured to operate, in response to the instructions, to treat the target plot (e.g., upon delivery of the treatment recommendation to the farm equipment 106a-b, etc.). In one or more embodiments, the farm equipment 106a-b (e.g., a sprayer, etc.) in the target field may be controlled automatically, through one or more scripts generated by the agricultural computer system 116, in connection with the instructions.

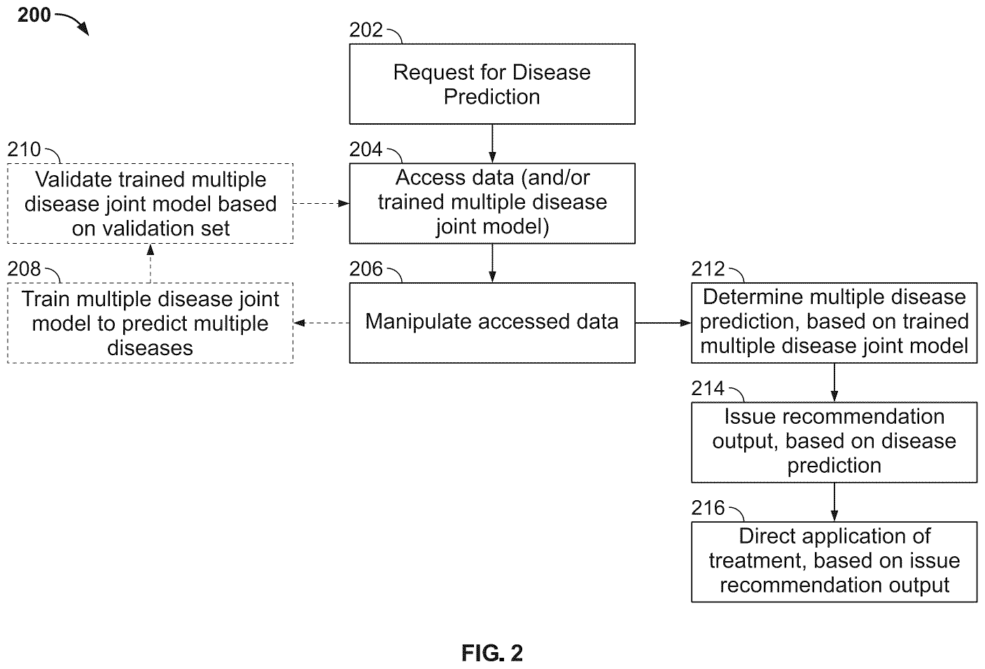

FIG. 2 illustrates an example method 200 for determining whether to treat a particular crop in a growing space, or not, based on predictions of specific crop disease likelihoods (e.g., occurrences, severities, combinations thereof, etc.). The example method 200 is described herein in connection with the system 100, and may be implemented, in whole or in part, in the agricultural computer system 116 of the system 100. However, it should be appreciated that the method 200, or other methods described herein, are not limited to the system 100 or the agricultural computer system 116. And, conversely, the systems, data structures, and the computing devices described herein are not limited to the example method 200.

At the outset in the method 200, the agricultural computer system 116 receives, at 202, a request from the user 103, or other user associated with a target plot (or target growing space) included in the growing spaces in the system 100, for a decision of whether or not to treat the target plot based on a predicted likelihood of one or more multiple crop disease types (e.g., corn grey leaf spot, soybean frogeye leaf spot, corn northern leaf blight, corn southern rust, soybean white mold, corn tar spot, soybean brownspot, etc.), along with a location of the target plot (and optionally a date or range of dates of interest, and/or other suitable input parameters characterizing the target plot). The request may be provided, to the agricultural computer system 116, via the communication device 104 (e.g., via an electronic message (e.g., email, SMS message, etc.), or via a mobile application such as, for example, the CLIMATE FIELDVIEW application, commercially available from Climate LLC, Saint Louis, Missouri; etc.).

In response to the request, in this embodiment, the agricultural computer system 116 accesses particular data, at 204, for the specific request, and in particular, the region 110 and/or fields 112a-c that include the target plot (in this example) and the particular multiple crop disease types. For example, the agricultural computer system 116 may access data, which are specific to the region 110, and specifically field 112b, in FIG. 1, and for specific crop disease types such as corn grey leaf spot, soybean frogeye leaf spot, corn northern leaf blight, corn southern rust, and soybean white mold. Other types of crops (e.g., wheat, canola, cotton, etc.), crop disease types, regions, treatments (e.g., fungicides, pesticides, herbicides, etc.), etc., may be included in other embodiments, whereby the agricultural computer system 116 accesses data specific to those features.

The accessed data may include, for example, various years of crop disease observation data indicative of a presence and/or severity of various types of crop diseases in various plots at different locations, with different dates of observations and different field conditions for the various plots. The data may be specific to plots or to fields including various plots, at a variety of different locations in the region 110, field 112b (in this example) or other regions. In this embodiment, the data include different data related to the plot, crop, performance, etc., including, without limitation, planting date for the crop, planting day of year, seeding rate, tillage type, surfactant usage, mode of treatment action, yields, weather data (e.g., weather scores, precipitation, relative humidity, temperature, solar radiation, etc.), maturity, drought monitor, previous year crops, location, application timing, crop type and details (e.g., trait stack, relative maturity, etc.), management practices (e.g., crop rotation, tilling, etc.), soil information (e.g., moisture, drainage, etc.), field topology (e.g., elevation, slope, surrounding terrain, etc.), etc.

Next in the method 200, the agricultural computer system 116 manipulates, at 206, the accessed data, in whole or in part, to define specific data features, for example. In this example, the agricultural computer system 116 determines the average crop disease presence and/or severity for multiple crop disease types included in the accessed data in different regions (e.g., in region 110, in fields 112a-c, etc.), at different levels. In particular, where a region (e.g., region 110, etc.) includes multiple counties, the agricultural computer system 116 may determine an average crop disease presence and/or severity for multiple crop disease types in each county and then the region overall. The agricultural computer system 116 then assigns the average crop disease presence and/or severity for multiple crop disease types to each county and then the region, at a centroid of the county/region.

In addition, as part of manipulating the accessed data, the agricultural computer system 116 may impute data to certain crop disease observations in certain plots, based on the averages and other aggregates in the regions in which the fields associated with the missing data is located.

The accessed, manipulated data is then separated by the agricultural computer system 116 into a training data set and a validation data set, where each set also includes crop disease observation data (e.g., crop disease presence and/or severity observations for multiple crop diseases at multiple plot locations and observation dates, etc.).

At 208, the agricultural computer system 116 then trains the multiple disease joint model (as presented above) based on the accessed and/or manipulated training data set. The multiple disease joint model, as explained above, includes a joint model capable of predicting multiple crop disease likelihoods, where the target crop disease type may have some dependencies across targets.

After training is completed, the agricultural computer system 116 validates the model, at 210, based on the validation data set. The validation of the model includes inputting the validation data set features to the trained multiple disease joint model and comparing the output (e.g., prediction of multiple crop disease type likelihoods, etc.) to the crop disease observation data included in the validation data set, as an indicator of whether the “correct” crop disease prediction likelihoods were made relative to the appropriate threshold, i.e., as an indication of performance of the trained model. When the performance of the model, as trained, is as desired or intended, the trained model is stored in memory for use as described below.

It should be appreciated that, as indicated by the dotted lines in FIG. 2 (at operations 208 and 210), the agricultural computer system 116 may retrain or update the model in various embodiments, at various intervals, by returning to step 204 to access data specific to crop disease observations for multiple crop disease types, in different regions. In this manner, the model may be trained or retrained apart from a specific request from the user 103 and/or the trained model may be available for use, by the agricultural computer system 116, without retraining or initially training for each request related to a prediction of likelihoods of multiple crop disease types at a particular plot location. The retraining may be employed, for example, to account for additional available data since the training of the model and, potentially, output from the model.

Next, the agricultural computer system 116 determines, at 212, a disease likelihood (e.g., occurrence, severity, combinations thereof, etc.) for multiple crop disease types (e.g., a prediction of a likelihood that a plot will experience a crop disease during the growing year, such as a 75% likelihood of corn grey leaf spot on the plot, a 30% likelihood of soybean frogeye leaf spot severity exceeding level 2, etc.), based on the trained model, where the details of the request are provided as input(s) to the trained multiple disease joint model. An input request may include, for example, without limitation, a collection of named inputs used by the model in the form of a python dictionary Javascript object, containing data corresponding to the growing area for which predicted disease risk is requested. One specific example includes {“latitude”: 35, “longitude”: −90, “day of year”: 200, “planting date”: “2023-04-01”, “crop”: “corn”, . . . , “etc.”}. That said, other forms and formats of requests may be included in other embodiments, which only necessarily include the inputs specific to the requested disease likelihood.

Once the disease likelihoods for multiple crop disease types are determined, based on the model, the agricultural computer system 116 issues, at 214, a disease prediction output to the user 103, or other user or to the farm equipment 106a-b, for example, as explained above, where the disease prediction output indicates a likelihood that a target plot (or field or other growing space) will experience multiple crop disease types (such as a crop experiencing a particular disease severity within a remaining growing season for the year, etc.).

An example disease prediction output table is illustrated below in Table 3. As shown in the example embodiment of Table 3, the prediction output indicates a predicted likelihood of different plots experiencing different types of crop diseases. For example, the illustrated disease prediction output table predicts a 5% likelihood that corn crops on Plot A (e.g., a specified target plot a location A, etc.) will develop corn grey leaf, a 50% likelihood that soybean crops on Plot A will develop soy frogeye leaf spot exceeding level 1, a 30% likelihood that soybean crops on Plot A will develop soy frogeye leaf spot exceeding level 2, a 70% likelihood that corn crops on Plot A will develop corn northern leaf blight, a 5% likelihood that corn crops on Plot A will develop corn southern rust, and a 20% likelihood that soybean crops on Plot A will develop soybean white mold.

TABLE 3

| | Plot A | Plot B | Plot C | Plot D |
|---|---|---|---|---|
| Corn Grey Leaf | 5% | 60% | 5% | 25% |
| Soy Frogeye Leaf Spot Lvl 1 | 50% | 5% | 80% | 20% |
| Soy Frogeye Leaf Spot Lvl 2 | 30% | 5% | 50% | 10% |
| Corn Northern Leaf Blight | 70% | 50% | 10% | 30% |
| Corn Southern Rust | 5% | 10% | 65% | 25% |
| Soybean White Mold | 20% | 10% | 20% | 15% |

As should be appreciated, in other embodiments the disease prediction output table may include more or less plots or other growing spaces at various locations (or a single plot), more or less (or other) types of crop diseases, etc. The disease prediction output maybe presented in forms other than a table, may be tailored to include diseases associated with only one type of crop (or a specified subset of crop types), may be tailored to specific crop disease types, may include a disease likelihood output for only one crop disease type (e.g., where the model provides benefits by being trained based on data for multiple crop disease types even if an output is only generated for one crop disease type, etc.), may include a particular severity or range of severities included with the disease prediction output, may incorporate severity into the disease prediction output, etc. A user 103 may specify which plots or other growing spaces, crops types, crop disease types, etc., should be included in the disease prediction output (such as by specifying desired filters in the request that is input to the agricultural computer system 116 for running the trained model).

Next, the agricultural computer system 116 directs, at 216, application of one or more treatments based on the prediction output from the trained multiple disease joint model. For example, the agricultural computer system 116 may direct application of treatment, at 216, for all crop disease types having a likelihood above a specified threshold (e.g., each crop disease likelihood above 30%, above 50%, above 70%, etc.), may direct application of treatment for a highest likelihood crop disease type (or multiple highest likelihood crop disease types), etc.

Directing the treatment application may include providing a recommendation output from the agricultural computer system 116 to the user 103, or other user or to the farm equipment 106a-b, for example, as explained above, where the recommendation indicates whether to treat the target field for a specified crop disease type, or not. In various implementations, the recommendation output may include a binary output, YES or NO, or 1 or 0, etc., whereby the one value indicates whether the model predicts a treatment that should be applied in view of the predicted likelihood of crops on the target plot developing a specific crop disease type. The farm equipment 106a-b may be used to apply the given treatment for one or more specific crop disease types, such as by spraying treatment on a plot and/or crops of the plot, etc.

Additionally, or alternatively, the modeling output may include a time series forecast view of disease for the field(s), or a disease risk map view for the field(s) and adjacent fields(s), whereby the grower is then enabled to assess the potential for one or more diseases to be present in the field(s). The grower 103, for example, may then make a decision, supported by the views (e.g., forecasts, maps, etc.) whether to apply or not to apply a treatment associated with one or more crops and/or one or more crop diseases.

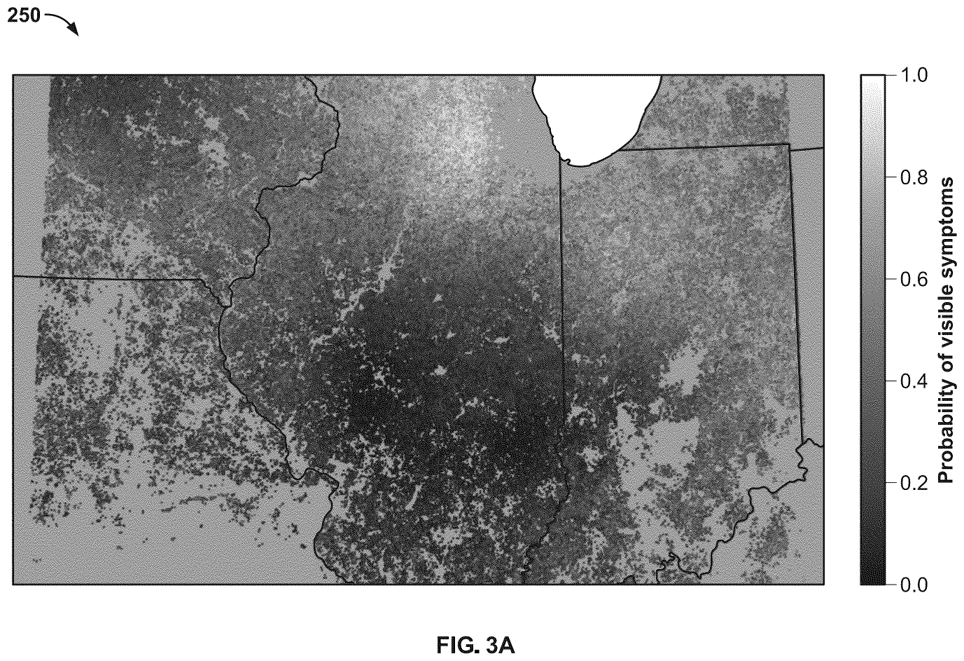

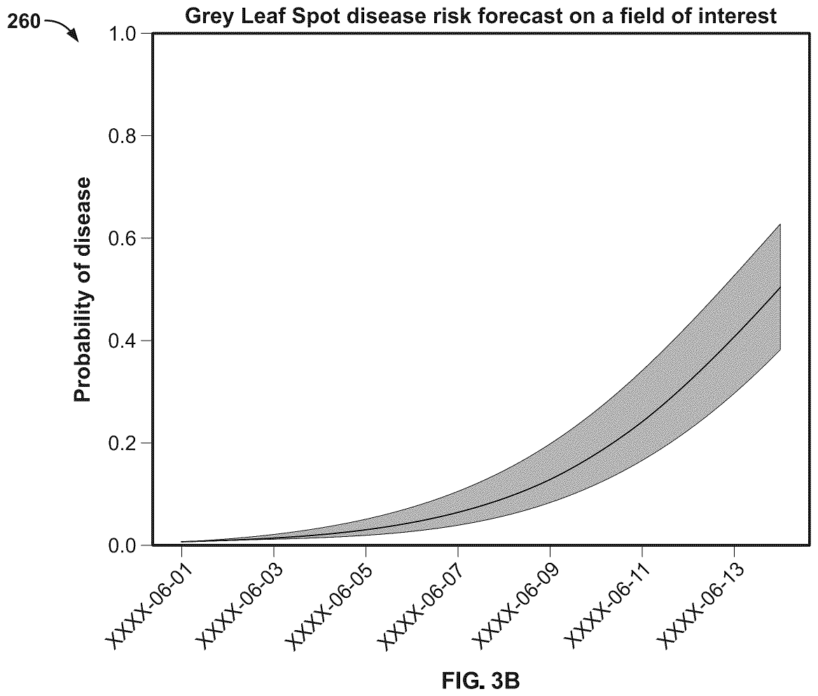

FIG. 3A illustrates an example disease risk map view 250. As shown in FIG. 3A, a probability of visible symptoms of a given crop disease type is illustrated across various locations on the risk map. In this example, a portion of the Midwest United States is included in the map, showing areas of relatively higher and lower probabilities of a given crop disease type having visible symptoms at different locations. In various implementations, multiple risk maps may be generated that each illustrate disease risk probabilities for different individual crop disease types, a single risk map may be used to illustrate probabilities for multiple different crop disease types (e.g., by using various patterns, color coding, indicators, etc.), and so on. Although FIG. 3A illustrates a risk map across multiple states, in other example embodiments the risk map may cover a smaller area that is more specific to an area of target field(s).

FIG. 3B illustrates an example time series forecast view 260. As shown in FIG. 3B, a probability of Grey Leaf Spot disease for a target field is plotted over a specified time interval (in the month of June in the illustrated example). Any suitable time interval may be used for the time series forecast, such as multiple days, weeks, months, etc., and may correspond to all or a portion of a growing season. In various implementations, multiple time series forecasts may be generated that each illustrate disease risk probabilities for different individual crop disease types over time, a time series forecast may be used to illustrate probabilities for multiple different crop disease types (e.g., by using various patterns, color coding, indicators, etc.), and so on.

As should be apparent, the disease likelihood prediction output of the trained model may be used for purposes in addition to, or as an alternative to, directing application of specific treatments. For example, depending on timing in a growing season or before a growing season for running the trained model, the user 103 may make a decision about which types of crops to plant in a field (e.g., by selecting a crop type that has a lowest likelihood of predicted crop diseases, by selecting a crop type that has a predicted disease likelihood that is easiest to prevent (or cheapest to prevent) with a specific treatment application, etc.

With further reference to FIG. 1, the user 103 (again, for example, a grower, a sales representative, another user, etc.) in the system 100 may own, operate or possess the communication device 104 (e.g., as a field manager computing device, etc.) in a growing location or associated with a growing location (e.g., one or more of the growing locations or plots 102, etc.), such as a field intended for agricultural activities or a management location for one or more agricultural fields. The communication device 104 is programmed, or configured, to provide field data to the agricultural computer system 116 via one or more networks (as indicated by arrowed lines in FIG. 1) (e.g., for use in identifying characteristics of a target field of the growing spaces, etc.). Again, the network(s) may each include, without limitation, one or more of local area networks (LANs), wide area network (WANs) (e.g., the Internet, etc.), mobile/cellular networks, virtual networks, and/or another suitable public and/or private networks capable of supporting communication among parts of the system 100 illustrated in FIG. 1, or any combination thereof.

Examples of field data may include, for example, (a) identification data (for example, acreage, field name, field identifiers, geographic identifiers, boundary identifiers, crop identifiers, and any other suitable data that may be used to identify farm land, such as a common land unit (CLU), lot and block number, a parcel number, geographic coordinates and boundaries, Farm Serial Number (FSN), farm number, tract number, field number, section, township, and/or range), (b) harvest data (for example, crop type, crop variety, crop rotation, whether the crop is grown organically, harvest date, Actual Production History (APH), expected yield, yield, crop price, crop revenue, grain moisture, tillage practice, and previous growing season information), (c) soil data (for example, type, composition, pH, organic matter (OM), cation exchange capacity (CEC)), (d) planting data (for example, planting date, seed(s) type, relative maturity (RM) of planted seed(s), seed population), (e) fertilizer data (for example, nutrient type (Nitrogen, Phosphorous, Potassium), application type, application date, amount, source, method), (f) chemical application data (for example, pesticide, herbicide, fungicide, other substance or mixture of substances intended for use as a plant regulator, defoliant, or desiccant, application date, amount, source, method), (g) irrigation data (for example, application date, amount, source, method), (h) weather data (for example, precipitation, rainfall rate, predicted rainfall, water runoff rate region, temperature, wind, forecast, pressure, visibility, clouds, heat index, dew point, humidity, snow depth, air quality, sunrise, sunset), (i) imagery data (for example, imagery and light spectrum information from an agricultural apparatus sensor, camera, computer, smartphone, tablet, unmanned aerial vehicle, planes or satellite), (j) scouting observations (photos, videos, free form notes, voice recordings, voice transcriptions, weather conditions (temperature, precipitation (current and over time), soil moisture, crop growth stage, wind velocity, relative humidity, dew point, black layer)), (k) soil, seed, crop phenology, pest and disease reporting, and predictions sources and databases, and (l) other data described herein, etc.

As described, data server 108 is communicatively coupled to the agricultural computer system 116 and is programmed, or configured, to send external data (e.g., data associated with growing spaces, etc.) to agricultural computer system 116 via the network(s) herein (e.g., for use with the multiple disease joint model (e.g., training, validation, application, etc.), etc.). The data server 108 may be owned or operated by the same legal person or entity as the agricultural computer system 116, or by a different person or entity, such as a government agency, non-governmental organization (NGO), and/or a private data service provider. Examples of external data may include location data, weather data, imagery data, soil data, seed data and treatment data as described herein, data from the various growing spaces herein, or statistical data relating to crop yields, among others (or other data as described herein). External data may include the same type of information as field data. In some embodiments, the external data may also be provided by data server 108 owned by the same entity that owns and/or operates the agricultural computer system 116. For example, the agricultural computer system 116 may include a data server focused exclusively on a type of data that might otherwise be obtained from third party sources, such as weather data to trial data to treatment data. In some embodiments, data server 108 may be incorporated or integrated, in whole or in part, in the agricultural computer system 116.

The system 100 also includes, as described above, the farm equipment 106a-b configured to plant, treat or harvest crops from one or more growing spaces (e.g., from one or more of the plots 102, etc.). In some examples, the farm equipment 106a-b may have one or more remote sensors fixed thereon, where the sensor(s) are communicatively coupled, either directly or indirectly, via the farm equipment 106a-b to the agricultural computer system 116 and are programmed, or configured, to send sensor data to agricultural computer system 116.

As described herein, examples of farm equipment 106a-b that may be included in the system 100 include tractors, combines, pickers, sprayers, planters, trucks, fertilizer equipment, aerial vehicles including unmanned aerial vehicles, and any other item of physical machinery or hardware, typically mobile machinery, and which may be used in tasks associated with agriculture and/or related to operations described herein. In some embodiments, a single unit of the farm equipment may comprise a plurality of sensors that are coupled locally in a network on the apparatus/equipment. A controller area network (CAN) is an example of such a network that can be installed in combines, harvesters, sprayers, and cultivators. In connection therewith, then, an application controller associated with the apparatus may be communicatively coupled to agricultural computer system 116 via the network(s) and programmed, or configured, to receive one or more scripts (e.g., from the agricultural computer system 116, etc.) that are used to control an operating parameter of the farm equipment 106a-b (or another agricultural vehicle or implement). For instance, a CAN bus interface may be used to enable communications from the agricultural computer system 116 to the farm equipment 106a and/or 106b, for example, such as through the CLIMATE FIELDVIEW DRIVE, available from Climate LLC, Saint Louis, Missouri. Sensor data may consist of the same type of information as field data. In some embodiments, remote sensors may not be fixed to farm equipment but may be remotely located in the field and may communicate with one or more networks of the system 100.

As indicated above, the network(s) of the system 100 are generally illustrated in FIG. 1 by arrowed lines. In connection therewith, the network(s) broadly represent any combination of one or more data communication networks including local area networks, wide area networks, internetworks or internets, using any of wireline or wireless links, including terrestrial or satellite links. The network(s) may be implemented by any medium or mechanism that provides for the exchange of data between the various elements of FIG. 1. The various elements of FIG. 1 may also have direct (wired or wireless) communications links. For instance, the farm equipment 106a-b in the system 100, data server 108, agricultural computer system 116, and other elements of the system 100 may each comprise an interface compatible with the network(s) and programmed, or configured, to use standardized protocols for communication across the networks, such as TCP/IP, Bluetooth, CAN protocol and higher-layer protocols, such as HTTP, TLS, and the like.

That said, the agricultural computer system 116 is programmed, or configured, generally, to receive field data from communication device 104, external data 120 from external data server 122, and sensor data from one or more remote sensors in the system 100. Agricultural computer system 116 may be further configured to host, use or execute one or more computer programs, other software elements, digitally programmed logic, such as FPGAs or ASICs, or any combination thereof, to perform translation and storage of data values, construction of digital models of one or more crops on one or more fields, generation of recommendations and notifications, and generation and sending of scripts, in the manner described further in other sections of this disclosure.

In an embodiment, agricultural computer system 116 is programmed with or comprises a communication layer 132, a presentation layer 134, a data management layer 140, a hardware/visualization layer 150, and a model and field data repository layer 160. “Layer,” in this context, refers to any combination of electronic digital interface circuits, microcontrollers, firmware, such as drivers, and/or computer programs, or other software elements.

Communication layer 132 may be programmed, or configured, to perform input/output interfacing functions including sending requests to communication device 104, data server 108, and remote sensor(s) for field data, external data, and sensor data respectively. Communication layer 132 may be programmed, or configured, to send the received data to the model and field data repository layer 160 to be stored as field data (e.g., in agricultural computer system 116, etc.).

Presentation layer 134 may be programmed, or configured, to generate a graphical user interface (GUI) to be displayed on communication device 104 (e.g., to interact with the agricultural computer system 116, to identify the target field(s), to select inputs, etc.), or other computers that are coupled to the agricultural computer system 116 through the network(s). The GUI may comprise controls for inputting data to be sent to the agricultural computer system 116, generating requests for models and/or recommendations, and/or displaying recommendations, notifications, models, and other field data.

Data management layer 140 may be programmed, or configured, to manage read operations and write operations involving the repository layer 160 and other functional elements of the system 100, including queries and result sets communicated between the functional elements of the system and the repository layer 160. Examples of data management layer 140 include JDBC, SQL server interface code, and/or HADOOP interface code, among others. The repository layer 160 may comprise a database. As used herein, the term “database” may refer to either a body of data, a relational database management system (RDBMS), or both. As used herein, a database may comprise any collection of data including hierarchical databases, relational databases, flat file databases, object-relational databases, object oriented databases, distributed databases, and any other structured collection of records or data that is stored in a computer system. Examples of RDBMS's include, but are not limited to, ORACLE®, MYSQL, IBM® DB2, MICROSOFT® SQL SERVER, SYBASE®, and POSTGRESQL databases. That said, any database may be used that enables the systems and methods described herein.

When field data is not provided directly to the agricultural computer system 116 via farm equipment (e.g., equipment 106a-b, etc.) that interacts with the agricultural computer system 116, the user 103 may be prompted via one or more user interfaces on the communication device 104 (served by the agricultural computer system 116) to input such data to the agricultural computer system 116. In an example embodiment, the user 103 may specify identification data by accessing a map on the communication device 104 (served by the agricultural computer system 116) and selecting specific CLUs that have been graphically shown on the map. In an alternative embodiment, the user 103 may specify data by accessing a map on the communication device 104 (served by the agricultural computer system 116) and drawing boundaries of the field over the map to indicate specific data. Such CLU selection, or map drawings, represent geographic identifiers. In alternative embodiments, the user 103 may specify data by accessing field identification data (provided as shape files or in a similar format) from the U.S. Department of Agriculture Farm Service Agency, or other source, via the communication device 104 and providing such field identification data to the agricultural computer system 116.

In an example embodiment, the agricultural computer system 116 is programmed to generate and cause displaying of a graphical user interface comprising a data manager for data input. After one or more fields (or associated data) have been identified using the methods described above, the data manager may provide one or more graphical user interface widgets which when selected can identify changes to the field, soil, crops, tillage, or nutrient practices, and/or which may provide comparison data related to treatments, yields, etc. identified by the disclosure herein for fields of the growing spaces. The data manager may include a timeline view, a spreadsheet view, a graphical view, and/or one or more editable programs.

In an embodiment, model and field data is stored in the model and field data repository layer 160. Model data comprises data models created for one or more fields. For example, a crop model may include a digitally constructed model of the development of a crop on the one or more fields. “Model,” in this context, refers to an electronic digitally stored set of executable instructions and data values, associated with one another, which are capable of receiving and responding to a programmatic or other digital call, invocation, or request for resolution based upon specified input values, to yield one or more stored or calculated output values that can serve as the basis of computer-implemented recommendations, output data displays, or machine control, among other things. Persons of skill in the field find it convenient to express models using mathematical equations, but that form of expression does not confine the models disclosed herein to abstract concepts; instead, each model herein may have a practical application in a computer in the form of stored executable instructions and data that implement the model using the computer. The model may include a model of past events on the one or more fields/plots, a model of the current status of the one or more fields/plots, and/or a model of predicted events on the one or more fields/plots. Model and field data may be stored in data structures in memory, rows in a database table, in flat files or spreadsheets, or other forms of stored digital data.

With reference again to FIG. 1, in an embodiment, instructions 135 of the agricultural computer system 116 may comprise a set of one or more pages of main memory, such as RAM, in the agricultural computer system 116 into which executable instructions have been loaded and which when executed cause the agricultural computer system 116 to perform the functions or operations that are described herein. For example, the instructions 135 may comprise a set of pages in RAM that contain instructions which, when executed, cause performing treatment decision functions described herein. The instructions may be in machine executable code in the instruction set of a CPU and may have been compiled based upon source code written in JAVA, C, C++, OBJECTIVE-C, or any other human-readable programming language or environment, alone or in combination with scripts in JAVASCRIPT, other scripting languages and other programming source text. The term “pages” is intended to refer broadly to any region within main memory and the specific terminology used in a system may vary depending on the memory architecture or processor architecture. In another embodiment, the instructions 135 also may represent one or more files, or projects of source code, that are digitally stored in a mass storage device, such as non-volatile RAM or disk storage, in the agricultural computer system 116 or a separate repository system, which when compiled or interpreted cause generating executable instructions which when executed cause the agricultural computer system 116 to perform the functions or operations that are described herein. In other words, the drawing figure may represent the manner in which programmers or software developers organize and arrange source code for later compilation into an executable, or interpretation into bytecode or the equivalent, for execution by the agricultural computer system 116.

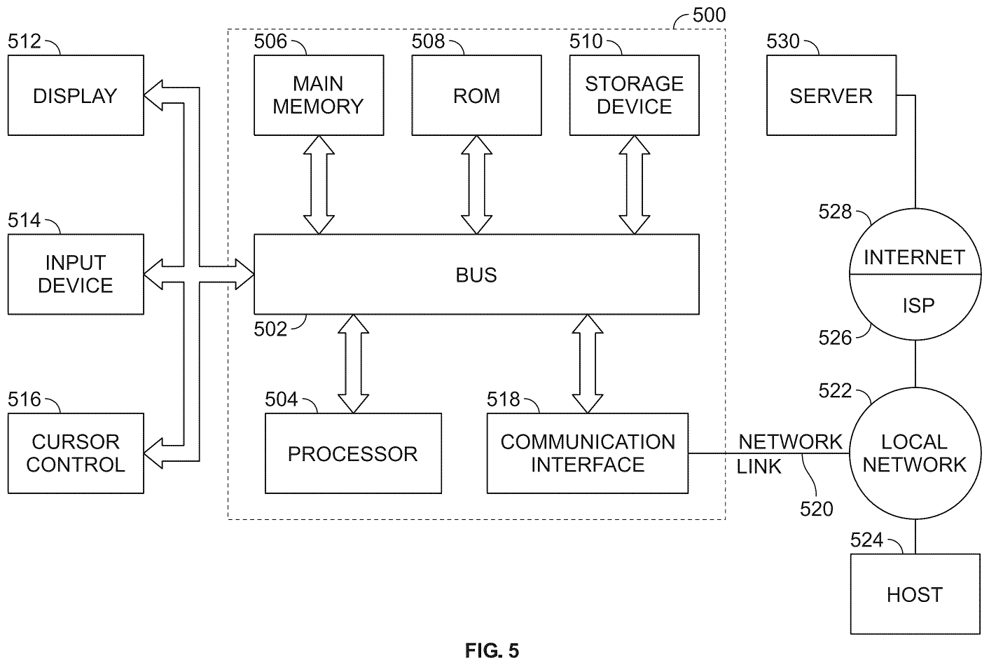

Hardware/visualization layer 150 comprises one or more central processing units (CPUs), memory controllers, and other devices, components, or elements of a computer system, such as volatile or non-volatile memory, non-volatile storage, such as disk, and I/O devices or interfaces as illustrated and described, for example, in connection with FIG. 5. The hardware/visualization layer 150 also may comprise programmed instructions that are configured to support visualization, virtualization, containerization, or other technologies.

For purposes of illustrating a clear example, FIG. 1 shows a limited number of instances of certain functional elements. However, in other embodiments, there may be any number of such elements. For example, embodiments may use thousands or millions of different mobile computing devices associated with different users/growers. Further, the agricultural computer system 116 and/or data server 108 may be implemented using two or more processors, cores, clusters, or instances of physical machines or virtual machines, configured in a discrete location or co-located with other elements in a datacenter, shared computing facility or cloud computing facility.

In an embodiment, the implementation of the functions described herein using one or more computer programs, or other software elements that are loaded into and executed using one or more general-purpose computers, will cause the general-purpose computers to be configured as a particular machine or as a computer that is specially adapted to perform the functions described herein. Further, each of the flow diagrams that are described further herein may serve, alone or in combination with the descriptions of processes and functions in prose herein, as algorithms, plans or directions that may be used to program a computer or logic to implement the functions that are described. In other words, all the prose text herein, and all the drawing figures, together are intended to provide disclosure of algorithms, plans or directions that are sufficient to permit a skilled person to program a computer to perform the functions that are described herein, in combination with the skill and knowledge of such a person given the level of skill that is appropriate for disclosures of this type.

In an embodiment, the user 103 interacts with the agricultural computer system 116 using the communication device 104 configured with an operating system and one or more application programs or apps. The communication device 104 also may interoperate with the agricultural computer system 116 independently and automatically under program control or logical control and direct user interaction is not always required. The communication device 104 broadly represents one or more of a smart phone, PDA, tablet computing device, laptop computer, desktop computer, workstation, or any other computing device capable of transmitting and receiving information and performing the functions described herein. The communication device 104 may communicate via a network using a mobile application stored on the communication device 104, and in some embodiments, the communication device 104 may be coupled using a cable or connector to one or more sensors and/or other apparatus in the system 100. The particular user 103 may own, operate or possess and use, in connection with system 100, more than one communication device at a time.

The mobile application associated with the communication device 104 may provide client-side functionality, via the network to one or more mobile computing devices. In an example embodiment, the communication device 104 may access the mobile application via a web browser or a local client application or app. The communication device 104 may transmit data to, and receive data from, one or more front-end servers, using web-based protocols, or formats, such as HTTP, XML and/or JSON, or app-specific protocols. In an example embodiment, the data may take the form of requests (e.g., for a decision, selection, etc.) and user information input, such as field data, into the mobile computing device. In some embodiments, the mobile application interacts with location tracking hardware and software on the communication device 104 which determines the location of the communication device 104 using standard tracking techniques, such as multilateration of radio signals, the global positioning system (GPS), WiFi positioning systems, or other methods of mobile positioning. In some cases, location data or other data associated with the communication device 104, user 103, and/or user account(s) may be obtained by queries to an operating system of the device or by requesting an app on the device to obtain data from the operating system.

In an embodiment, in addition to other functionalities described herein, the communication device 104 sends field data to agricultural computer system 116 comprising or including, but not limited to, data values representing one or more of: a geographical location of the one or more fields, tillage information for the one or more fields, crops planted in the one or more fields, and soil data extracted from the one or more fields. The communication device 104 may send field data in response to user input from the user 103 specifying the data values for the one or more fields. Additionally, the communication device 104 may automatically send field data when one or more of the data values becomes available to the communication device 104. For example, the communication device 104 may be communicatively coupled to a remote sensor in the system 100, and in response to an input received at the sensor, the communication device 104 may send field data to agricultural computer system 116 representative of the input. Field data identified in this disclosure may be input and communicated using electronic digital data that are communicated between computing devices using parameterized URLs over HTTP, or another suitable communication or messaging protocol. In that sense, in some aspects of the present disclosure, the field data provided by the communication device 104 may also be stored as external data (e.g., where the field data are collected as part of harvesting crops from growing spaces, etc.), for example, in data server 108.

A commercial example of the mobile application described above is CLIMATE FIELDVIEW, commercially available from Climate LLC, Saint Louis, Missouri. The CLIMATE FIELDVIEW application, or other applications, may be modified, extended, or adapted to include features, functions, and programming that have not been disclosed earlier than the filing date of this disclosure. In one embodiment, the mobile application comprises an integrated software platform that allows a grower to make fact-based decisions for their operation because it combines historical data about the grower's fields with any other data that the grower wishes to compare. The combinations and comparisons may be performed in real time and are based upon scientific models that provide potential scenarios to permit the grower to make better, more informed decisions.

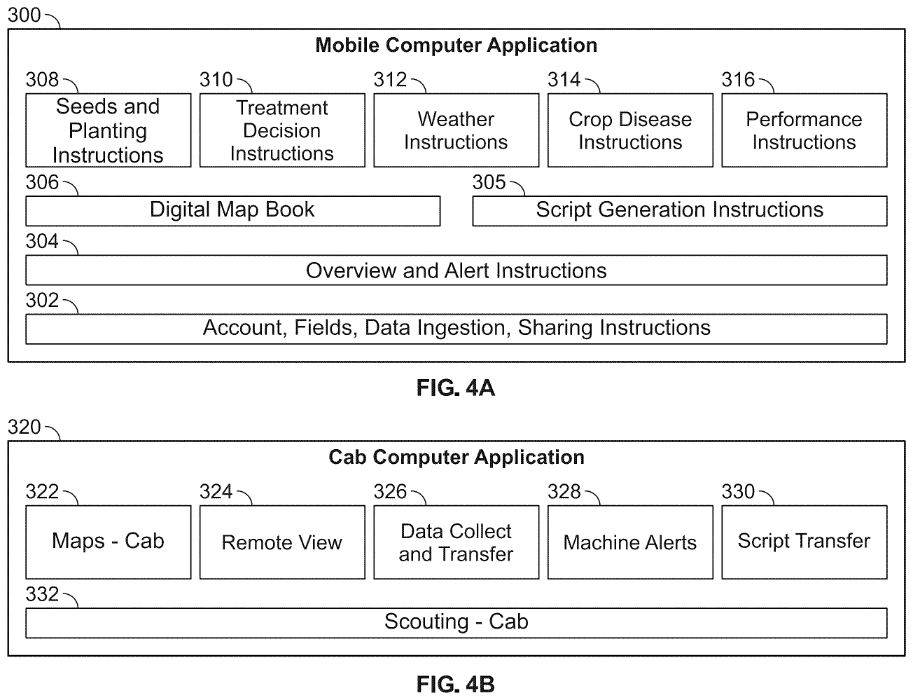

FIGS. 4A-4B illustrate two views of an example logical organization of sets of instructions in main memory when an example mobile application is loaded for execution. Each named element represents a region of one or more pages of RAM, or other main memory, or one or more blocks of disk storage, or other non-volatile storage, and the programmed instructions within those regions. In one embodiment, in FIG. 4A, a mobile computer application 300 comprises account, fields, data ingestion, sharing instructions 302, overview and alert instructions 304, digital map book instructions 306, seeds and planting instructions 308, treatment decision instructions 310, weather instructions 312, crop disease type instructions 314, and performance instructions 316.

In one embodiment, a mobile computer application 300 comprises account, fields, data ingestion, sharing instructions 302 which are programmed to receive, translate, and ingest field data from third party systems via manual upload or APIs. Data types may include field boundaries, yield maps, as-planted maps, soil test results, as-applied maps, and/or management zones, among others. Data formats may include shape files, native data formats of third parties, and/or farm management information system (FMIS) exports, among others. Receiving data may occur via manual upload, e-mail with attachment, external APIs that push data to the mobile application, or instructions that call APIs of external systems to pull data into the mobile application. In one embodiment, mobile computer application 300 comprises a data inbox. In response to receiving a selection of the data inbox, the mobile computer application 300 may display a graphical user interface for manually uploading data files and importing uploaded files to a data manager.

In one embodiment, digital map book instructions 306 comprise field map data layers stored in device memory and are programmed with data visualization tools and geospatial field notes. This provides growers with convenient information close at hand for reference, logging and visual insights into field performance and other options provided herein. In one embodiment, overview and alert instructions 304 are programmed to provide an operation-wide view of what is important to the grower, and timely recommendations to take action or focus on particular issues. This permits the grower to focus time on what needs attention, to save time and preserve yield throughout the season. In one embodiment, seeds and planting instructions 308 are programmed to provide tools for seed selection, hybrid placement, and script creation, including variable rate (VR) script creation, based upon scientific models and empirical data. This enables growers to maximize yield, or return on investment, through optimized seed purchase, placement and population.

In one embodiment, script generation instructions 305 are programmed to provide an interface for generating scripts, including variable rate (VR) fertility scripts. The interface enables growers to create scripts for field implements, such as treatment decisions, planting, and irrigation. For example, a planting script interface may comprise tools for identifying a type of seed for planting. Upon receiving a selection of the seed type, mobile computer application 300 may display one or more fields broken into management zones, such as the field map data layers created as part of digital map book instructions 306. In one embodiment, the management zones comprise soil zones along with a panel identifying each soil zone and a soil name, texture, drainage for each zone, or other field data. Mobile computer application 300 may also display tools for editing or creating such as graphical tools for drawing management zones, such as soil zones, over a map of one or more fields. Planting procedures may be applied to all management zones or different planting procedures may be applied to different subsets of management zones. When a script is created, mobile computer application 300 may make the script available for download in a format readable by an application controller, such as an archived or compressed format. Additionally, and/or alternatively, a script may be sent directly to a cab computer (e.g., associated with farm equipment 106a and/or 106b, etc.) from mobile computer application 300 and/or uploaded to one or more data servers and stored for further use.

In one embodiment, treatment decision instructions 310 are programmed to provide tools to inform decisions by visualizing or instruction about the application of one or more candidate treatments to crops in a particular field. This enables growers to potentially enhance yield or return on investment through treatment application during the season.

Example programmed functions include displaying images to enable tuning application(s) of treatment across multiple zones; output of scripts to drive machinery; tools for mass data entry and adjustment; and/or maps for data visualization, among others. Treatment decision instructions 310 also may be programmed to generate and cause displaying a treatment graph, indicative of the application of the treatment to one or more target fields, but not others based on the functions explained herein. In one embodiment, the treatment graph may include one or more user input features, such as dials or slider bars, to dynamically change the candidate treatment programs so that the grower may alter the parameters of the treatment decision. Treatment instructions 310 also may be programmed to generate and cause displaying a treatment decision or indications.

In one embodiment, weather instructions 312 are programmed to provide field-specific recent weather data and forecasted weather information. This enables growers to save time and have an efficient integrated display with respect to daily operational decisions.

In one embodiment, crop disease type instructions 314 are programmed to provide timely remote sensing images highlighting in-season crop variation, multiple crop disease types and potential concerns. Example programmed functions include cloud checking, to identify possible clouds or cloud shadows; determining treatment indices based on field images; graphical visualization of scouting layers, including, for example, those related to field health, and viewing and/or sharing of scouting notes; recording observations of different crop disease type presence and/or severity; and/or downloading satellite images from multiple sources and prioritizing the images for the grower, among others.

In one embodiment, performance instructions 316 are programmed to provide reports, analysis, and insight tools using on-farm data for evaluation, insights and decisions. This enables the grower to seek improved outcomes for the next year through fact-based conclusions about why return on investment was at prior levels, and insight into yield-limiting factors. The performance instructions 316 may be programmed to communicate via the network(s) to back-end analytics programs executed at agricultural computer system 116 and/or data server 108 and configured to analyze metrics, such as yield, yield differential, hybrid, population, SSURGO zone, soil test properties, or elevation, among others. Programmed reports and analysis may include yield variability analysis, treatment effect estimation, benchmarking of yield and other metrics against other growers based on anonymized data collected from many growers, or data for seeds and planting, among others.

Applications having instructions configured in this way may be implemented for different computing device platforms while retaining the same general user interface appearance. For example, the mobile application may be programmed for execution on tablets, smartphones, or server computers that are accessed using browsers at client computers. Further, the mobile application as configured for tablet computers, or smartphones, may provide a full app experience, or a cab app experience, that is suitable for the display and processing capabilities of a cab computer (e.g., associated with farm equipment 106a and/or 106b, etc.). For example, referring now to FIG. 4B, in one embodiment a cab computer application 320 (e.g., as accessible in one of farm equipment 106a, 106b, etc.) may comprise maps-cab instructions 322, remote view instructions 324, data collect and transfer instructions 326, machine alerts instructions 328, script transfer instructions 330, and scouting-cab instructions 332. The code base for the instructions of FIG. 4B may be the same as for FIG. 4A and executables implementing the code may be programmed to detect the type of platform on which they are executing and to expose, through a graphical user interface, only those functions that are appropriate to a cab platform or full platform. This approach enables the system to recognize the distinctly different user experience that is appropriate for an in-cab environment and the different technology environment of the cab. The maps-cab instructions 322 may be programmed to provide map views of fields, farms or regions that are useful in directing machine operation. The remote view instructions 324 may be programmed to turn on, manage, and provide views of machine activity in real-time or near real-time to other computing devices connected to the agricultural computer system 116 via wireless networks, wired connectors or adapters, and the like. The data collect and transfer instructions 326 may be programmed to turn on, manage, and provide transfer of data collected at sensors and controllers to the agricultural computer system 116 via wireless networks, wired connectors or adapters, and the like (e.g., via network(s) in the system 100, etc.). The machine alerts instructions 328 may be programmed to detect issues with operations of the machines or tools that are associated with the cab and generate operator alerts. The script transfer instructions 330 may be configured to transfer in scripts of instructions that are configured to direct machine operations or the collection of data. The scouting-cab instructions 332 may be programmed to display location-based alerts and information received from the agricultural computer system 116 based on the location of the communication device 104, farm equipment 106a-b, or sensors in the field (of the growing spaces) and ingest, manage, and provide transfer of location-based scouting observations to the agricultural computer system 116 based on the location of the farm equipment 106a-b, or sensors in the field.

In an embodiment, data server 108 stores external data 120 from the data server 122, including soil data representing soil composition for the one or more fields and weather data representing temperature and precipitation on the one or more fields (and/or other data). The weather data may include past and present weather data as well as forecasts for future weather data. In an embodiment, data server 108 comprises a plurality of servers hosted by different entities. For example, a first server may contain soil composition data while a second server may include weather data. Additionally, soil composition data may be stored in multiple servers. For example, one server may store data representing percentage of sand, silt, and clay in the soil while a second server may store data representing percentage of organic matter (OM) in the soil. Further, in some embodiments, the data server 108, again, may include data associated with the growing spaces with regard to available seeds for use in comparisons, etc.

In an embodiment, remote sensors in the system 100 may comprise one or more sensors that are programmed, or configured, to produce one or more observations related to growing spaces, trials therein, etc. Remote sensors may be aerial sensors, such as satellites, vehicle sensors, planting equipment sensors, tillage sensors, fertilizer or insecticide application sensors, harvester sensors, and any other implement capable of receiving data from the one or more fields (e.g., associated with one or more of the growing spaces, etc.). In an embodiment, farm equipment 106a-b may include an application controller programmed, or configured, to receive instructions from agricultural computer system 116. The application controller may also be programmed, or configured, to control an operating parameter of the farm equipment 106a-b. Other embodiments may use any combination of sensors and controllers, of which the following are merely selected examples.

The system 100 may obtain or ingest data under grower control, on a mass basis from a large number of growers who have contributed trial data or other data to a shared database system. This form of obtaining data may be termed “manual data ingest” as one or more user-controlled computer operations are requested, or triggered, to obtain data for use by the agricultural computer system 116. As an example, the CLIMATE FIELDVIEW application, commercially available from Climate LLC, Saint Louis, Missouri, may be operated to export data to agricultural computer system 116 for storing in the field data repository 160.

For example, seed monitor systems can both control planter apparatus components and obtain planting data, including signals from seed sensors via a signal harness that comprises a CAN backbone and point-to-point connections for registration and/or diagnostics. Seed monitor systems can be programmed, or configured, to display seed spacing, population and other information to the user via a cab computer of the apparatus, or other devices within the system 100.

Likewise, yield monitor systems may contain yield sensors for harvester apparatus that send yield measurement data to a cab computer of the apparatus, or other devices within the system 100. Yield monitor systems may utilize one or more remote sensors to obtain grain moisture measurements in a combine, or other harvester, and transmit these measurements to the user 103 via the cab computer, or other devices within the system 100.

In an embodiment, examples of sensors that may be used with any moving vehicle, or apparatus of the type described elsewhere herein, include kinematic sensors and position sensors. Kinematic sensors may comprise any of speed sensors, such as radar or wheel speed sensors, accelerometers, or gyros. Position sensors may comprise GPS receivers or transceivers, or WiFi-based position or mapping apps that are programmed to determine location based upon nearby WiFi hotspots, among others.

In an embodiment, examples of sensors that may be used with tractors, or other moving vehicles, include engine speed sensors, fuel consumption sensors, area counters or distance counters that interact with GPS or radar signals, PTO (power take-off) speed sensors, tractor hydraulics sensors configured to detect hydraulics parameters, such as pressure or flow, and/or and hydraulic pump speed, wheel speed sensors or wheel slippage sensors. In an embodiment, examples of controllers that may be used with tractors include hydraulic directional controllers, pressure controllers, and/or flow controllers; hydraulic pump speed controllers; speed controllers or governors; hitch position controllers; or wheel position controllers provide automatic steering.

In an embodiment, examples of sensors that may be used with seed planting equipment, such as planters, drills, or air seeders, include seed sensors, which may be optical, electromagnetic, or impact sensors; downforce sensors, such as load pins, load cells, pressure sensors; soil property sensors, such as reflectivity sensors, moisture sensors, electrical conductivity sensors, optical residue sensors, or temperature sensors; component operating criteria sensors, such as planting depth sensors, downforce cylinder pressure sensors, seed disc speed sensors, seed drive motor encoders, seed conveyor system speed sensors, or vacuum level sensors; or pesticide application sensors, such as optical or other electromagnetic sensors, or impact sensors. In an embodiment, examples of controllers that may be used with such seed planting equipment include: toolbar fold controllers, such as controllers for valves associated with hydraulic cylinders; downforce controllers, such as controllers for valves associated with pneumatic cylinders, airbags, or hydraulic cylinders, and programmed for applying downforce to individual row units or an entire planter frame; planting depth controllers, such as linear actuators; metering controllers, such as electric seed meter drive motors, hydraulic seed meter drive motors, or swath control clutches; hybrid selection controllers, such as seed meter drive motors, or other actuators programmed for selectively allowing or preventing seed or an air-seed mixture from delivering seed to or from seed meters or central bulk hoppers; metering controllers, such as electric seed meter drive motors, or hydraulic seed meter drive motors; seed conveyor system controllers, such as controllers for a belt seed delivery conveyor motor; marker controllers, such as a controller for a pneumatic or hydraulic actuator; or pesticide application rate controllers, such as metering drive controllers, orifice size or position controllers.

In an embodiment, examples of sensors that may be used with tillage equipment include position sensors for tools, such as shanks or discs; tool position sensors for such tools that are configured to detect depth, gang angle, or lateral spacing; downforce sensors; or draft force sensors. In an embodiment, examples of controllers that may be used with tillage equipment include downforce controllers or tool position controllers, such as controllers configured to control tool depth, gang angle, or lateral spacing.

In an embodiment, examples of sensors that may be used in relation to an apparatus for applying fertilizer, insecticide, fungicide, herbicide, and the like, such as on-planter starter fertilizer systems, subsoil fertilizer applicators, or fertilizer sprayers, include: fluid system criteria sensors, such as flow sensors or pressure sensors; sensors indicating which spray head valves or fluid line valves are open; sensors associated with tanks, such as fill level sensors; sectional or system-wide supply line sensors, or row-specific supply line sensors; or kinematic sensors, such as accelerometers disposed on sprayer booms. In an embodiment, examples of controllers that may be used with such apparatus include pump speed controllers; valve controllers that are programmed to control pressure, flow, direction, PWM and the like; or position actuators, such as for boom height, subsoiler depth, or boom position.

In an embodiment, examples of sensors that may be used with harvesters include yield monitors, such as impact plate strain gauges or position sensors, capacitive flow sensors, load sensors, weight sensors, or torque sensors associated with elevators or augers, or optical or other electromagnetic grain height sensors; grain moisture sensors, such as capacitive sensors; grain loss sensors, including impact, optical, or capacitive sensors; header operating criteria sensors, such as header height, header type, deck plate gap, feeder speed, and reel speed sensors; separator operating criteria sensors, such as concave clearance, rotor speed, shoe clearance, or chaffer clearance sensors; auger sensors for position, operation, or speed; or engine speed sensors. In an embodiment, examples of controllers that may be used with harvesters include header operating criteria controllers for elements, such as header height, header type, deck plate gap, feeder speed, or reel speed; separator operating criteria controllers for features such as concave clearance, rotor speed, shoe clearance, or chaffer clearance; or controllers for auger position, operation, or speed.

In an embodiment, examples of sensors that may be used with grain carts include weight sensors, or sensors for auger position, operation, or speed. In an embodiment, examples of controllers that may be used with grain carts include controllers for auger position, operation, or speed.

In an embodiment, examples of sensors and controllers may be installed in unmanned aerial vehicle (UAV) apparatus or “drones.” Such sensors may include cameras with detectors effective for any range of the electromagnetic spectrum including visible light, infrared, ultraviolet, near-infrared (NIR), and the like; accelerometers; altimeters; temperature sensors; humidity sensors; pitot tube sensors or other airspeed or wind velocity sensors; battery life sensors; or radar emitters and reflected radar energy detection apparatus; other electromagnetic radiation emitters and reflected electromagnetic radiation detection apparatus. Such controllers may include guidance or motor control apparatus, control surface controllers, camera controllers, or controllers programmed to turn on, operate, obtain data from, manage and configure any of the foregoing sensors.

In an embodiment, sensors and controllers may be affixed to a soil sampling and measurement apparatus that is configured, or programmed, to sample soil and perform soil chemistry tests, soil moisture tests, and other tests pertaining to soil.

In an embodiment, sensors and controllers may comprise weather devices for monitoring weather conditions of fields.

In an embodiment, the agricultural computer system 116 is programmed, or configured, to create an agronomic model. In this context, an agronomic model is a data structure in memory of the agricultural computer system 116 that comprises field data, such as identification data and harvest data for one or more fields. The agronomic model may also comprise calculated agronomic properties which describes either conditions which may affect the growth of one or more crops on a field, or properties of the one or more crops, or both. Additionally, an agronomic model may comprise recommendations based on agronomic factors, such as crop recommendations, irrigation recommendations, planting recommendations, fertilizer recommendations, fungicide recommendations, pesticide recommendations, harvesting recommendations and other crop management recommendations. The agronomic factors may also be used to estimate one or more crop related results, such as agronomic yield. The agronomic yield of a crop is an estimate of quantity of the crop that is produced, or in some examples, the revenue or profit obtained from the produced crop.

In an embodiment, the agricultural computer system 116 may use a preconfigured agronomic model to calculate agronomic properties related to currently received location and crop information for one or more fields. The preconfigured agronomic model is based upon previously processed field data, including but not limited to, identification data, harvest data, fertilizer data, and weather data. The preconfigured agronomic model may have been cross validated to ensure accuracy of the model. Cross validation may include comparison to ground truthing that compares predicted results with actual results on a field, such as a comparison of precipitation estimate with a rain gauge or sensor providing weather data at the same or nearby location, or a comparison of treatment recommendations to validation data.

According to one example embodiment, the techniques described herein are implemented by one or more special-purpose computing devices. The special-purpose computing devices may be hard-wired to perform the techniques, or may include digital electronic devices, such as one or more application-specific integrated circuits (ASICs) or field programmable gate arrays (FPGAs), that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be a desktop computer systems, portable computer systems, handheld devices, networking devices or any other device that incorporates hard-wired and/or program logic to implement the techniques.

For example, FIG. 5 is a block diagram that illustrates a computer system 500 upon which embodiments of the present disclosure may be implemented. Computer system 500 includes a bus 502 or other communication mechanism for communicating information, and a hardware processor 504 coupled with bus 502 for processing information. Hardware processor 504 may be, for example, a general purpose microprocessor.

Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Such instructions, when stored in non-transitory storage media accessible to processor 504, render computer system 500 into a special-purpose machine that is customized to perform the operations specified in the instructions.

Computer system 500 further includes a read only memory (ROM) 508, or other static storage device coupled to bus 502, for storing static information and instructions for processor 504. A storage device 510, such as a magnetic disk, optical disk, or solid-state drive, is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes; a first axis (e.g., x, etc.) and a second axis (e.g., y, etc.), that allows the device to specify positions in a plane.

Computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein. In alternative embodiments, hard-wired circuitry may be used in place of, or in combination with, software instructions.

The term “storage media” as used herein refers to any non-transitory media that stores data and/or instructions that cause a machine to operate in a specific fashion. Such storage media may comprise non-volatile media and/or volatile media. Non-volatile media includes, for example, optical disks, magnetic disks, or solid-state drives, such as storage device 510. Volatile media includes dynamic memory, such as main memory 506. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from, but may be used in conjunction with, transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infrared data communications.

Various forms of media may be involved in carrying one or more sequences of one or more instructions to processor 504 for execution. For example, the instructions may initially be carried on a magnetic disk or solid-state drive of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infrared signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card, cable modem, satellite modem, or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are example forms of transmission media.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518.

The received code may be executed by processor 504 as it is received, and/or stored in storage device 510, or other non-volatile storage for later execution.

With that said, it should be appreciated that the functions described herein, in some embodiments, may be described in computer executable instructions stored on a computer readable media, and executable by one or more processors. The computer readable media is a non-transitory computer readable media. By way of example, and not limitation, such computer readable media can include RAM, ROM, EEPROM, CD-ROM or other optical disk storage, magnetic disk storage or other magnetic storage device, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following operations: (a) receiving a request for a crop disease prediction related to treatment of a target plot for one or more crop disease, the request including crop disease type data and location data relating to the target plot, the crop disease type data including multiple identifiers each associated with a different one of multiple crop disease types; (b) accessing a multiple disease joint model consistent with the location data; (c) determining, via the multiple disease joint model, a first disease likelihood output and a second disease likelihood output based on at least the location data, the first disease likelihood output and the second disease likelihood output each associated with a different one of the multiple disease types; (d) generating a treatment recommendation based on the first disease likelihood output and the second disease likelihood output of the multiple disease joint model; and (e) directing application of at least one treatment to the target plot, based on the treatment recommendation output.

Examples and embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail. In addition, advantages and improvements that may be achieved with one or more example embodiments disclosed herein may provide all or none of the above mentioned advantages and improvements and still fall within the scope of the present disclosure.

Specific values disclosed herein are example in nature and do not limit the scope of the present disclosure. The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may also be suitable for the given parameter (i.e., the disclosure of a first value and a second value for a given parameter can be interpreted as disclosing that any value between the first and second values could also be employed for the given parameter). For example, if Parameter X is exemplified herein to have value A and also exemplified to have value Z, it is envisioned that parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, and 3-9.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “in communication with,” or “included with” another element or layer, it may be directly on, engaged, connected or coupled to, or associated or in communication or included with the other feature, or intervening features may be present. As used herein, the term “and/or” and the phrase “at least one of” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for directing crop disease treatments to plots, the computer-implemented method comprising:
receiving, by a computing device, a request for a crop disease prediction related to treatment of a target plot for one or more crop disease, the request including crop disease type data and location data relating to the target plot, the crop disease type data including multiple identifiers each associated with a different one of multiple crop disease types;
accessing, by the computing device, a multiple disease joint model consistent with the location data;
determining, by the computing device, via the multiple disease joint model, a first disease likelihood output and a second disease likelihood output based on at least the location data, the first disease likelihood output and the second disease likelihood output each associated with a different one of the multiple disease types;
generating, by the computing device, a treatment recommendation based on the first disease likelihood output and the second disease likelihood output of the multiple disease joint model; and
directing, by the computing device, application of at least one treatment to the target plot, based on the treatment recommendation output.

2. The computer-implemented method of claim 1, wherein the multiple disease joint model includes at least one of a coregionalization architecture with a separable covariance function, a linear regression model, a neural network regression model, a neural network covariance function, a vector autoregression architecture, a multi-task learning architecture, a shared smoothing penalties architecture, and a Gaussian process model.

3. The computer-implemented method of claim 2, wherein the multiple disease joint model includes a coregionalization architecture to jointly model occurrence probabilities and/or disease severity probabilities of multiple crop disease types, where model data is shared across the multiple crop disease types, locations of multiple plots, and multiple observation dates, using a separable covariance function.

4. The computer-implemented method of claim 3, wherein the multiple disease joint model includes at least one of a linear regression mean function and a neural network regression mean function for relating input parameters characterizing the target plot to likelihood probabilities of multiple crop disease types.

5. The computer-implemented method of claim 1, wherein:
the multiple disease joint model includes a Gaussian process model that interpolates data across plot locations and crop disease observation dates; and
an output of the multiple disease joint model includes an output of a neural network combined with a smooth Gaussian process.

6. The computer-implemented method of claim 1, further comprising training the multiple disease joint model, based on historical data associated with multiple plots and multiple crop disease types.

7. The computer-implemented method of claim 6, wherein inputs for training the multiple disease joint model include, for each of the multiple plots:
a location of the plot;
a presence or severity of multiple crop diseases at the plot; and
a date of observation of crops of the plot to determine the presence or severity of the multiple crop diseases.

8. The computer-implemented method of claim 7, wherein the inputs for training the multiple disease joint model include, for each of the multiple plots, at least one of soil information of the plot, field topology information of the plot, weather information associated with the plot, field management practice information associated with the plot, and hybrid/genetic seed information associated with crops on the plot.

9. The computer-implemented method of claim 6, wherein training the model includes:
accessing data specific to a region of the target plot;
manipulating, by the computing device, the accessed data; and
training, by the computing device, the multiple disease joint model based on at least a portion of the manipulated data.

10. The computer-implemented method of claim 1, further comprising treating the target plot with the treatment in response to the treatment recommendation.

11. The computer-implemented method of claim 10, wherein treating the target plot with the treatment includes applying the treatment to crops in the target plot.

12. The computer-implemented method of claim 10, further comprising:
receiving, at a communication device of a user associated with the target plot, the treatment recommendation; and
causing operation of one or more agricultural apparatuses at the target plot to apply the treatment to the crops in the target plot.

13. The computer-implemented method of claim 1, further comprising providing a forecasted disease risk map and/or a time series view, via an application and/or website, the map and/or view indicative of the first disease likelihood output and the second disease likelihood output.

14. The computer-implemented method of claim 1, wherein the request for the crop disease prediction is specific to a first crop type, the method further comprising:
receiving, by the computing device, a second request for a second crop disease prediction related to treatment of a second crop type at the target plot;
determining, by the computing device, via the multiple disease joint model, a third disease likelihood output and a fourth disease likelihood output, based on at least the location data and the second crop type, the third disease likelihood output and the fourth disease likelihood output each associated with the second crop type and a different one of the multiple disease types; and
generating, by the computing device, a second treatment recommendation based on the third disease likelihood output and the fourth disease likelihood output.

15. The computer-implemented method of claim 1, further comprising:
receiving, by the computing device, a second request for a second crop disease prediction related to treatment of a second target plot;
determining, by the computing device, via the multiple disease joint model, a third disease likelihood output and a fourth disease likelihood output, based on at least location data of the second target plot, the third disease likelihood output and the fourth disease likelihood output each associated with the second target plot and a different one of the multiple disease types; and
generating, by the computing device, a second treatment recommendation based on the third disease likelihood output and the fourth disease likelihood output.

16. A system for directing crop disease treatments to plots, the system comprising at least one computing device configured to:
receive a request for a crop disease prediction related to treatment of a target plot for one or more crop disease, the request including crop disease type data and location data relating to the target plot, the crop disease type data including multiple identifiers each associated with a different one of multiple crop disease types;
access a multiple disease joint model consistent with the location data;
determine, via the multiple disease joint model, a first disease likelihood output and a second disease likelihood output based on at least the location data, the first disease likelihood output and the second disease likelihood output each associated with a different one of the multiple disease types;
generate a treatment recommendation based on the first disease likelihood output and the second disease likelihood output of the multiple disease joint model

17. The system of claim 16, further comprising at least one agricultural machine configured to apply the treatment to crops in the target plot.

18. A non-transitory computer-readable storage medium including computer-executable instructions for use in directing crop disease treatments to plots, which when executed by at least one processor, cause the at least one processor to:
receive a request for a crop disease prediction related to treatment of a target plot for one or more crop disease, the request including crop disease type data and location data relating to the target plot, the crop disease type data including multiple identifiers each associated with a different one of multiple crop disease types;
access a multiple disease joint model consistent with the location data;
determine, via the multiple disease joint model, a first disease likelihood output and a second disease likelihood output based on at least the location data, the first disease likelihood output and the second disease likelihood output each associated with a different one of the multiple disease types;
generate a treatment recommendation based on the first disease likelihood output and the second disease likelihood output of the multiple disease joint model.

19. The non-transitory computer-readable storage medium of claim 18, wherein the multiple disease joint model includes a coregionalization architecture to jointly model occurrence probabilities and/or disease severity probabilities of multiple crop disease types, where model data is shared across the multiple crop disease types, locations of multiple plots, and multiple observation dates, using a separable covariance function.

20. The non-transitory computer-readable storage medium of claim 18, wherein:
the multiple disease joint model includes a Gaussian process model that interpolates data across plot locations and crop disease observation dates; and
an output of the multiple disease joint model includes an output of a neural network combined with a smooth Gaussian process.
